(19) United States
(12) Patent Application Publication
(10) Pub. No.: US 2018/0139176 A1
(43) Pub. Date: May 17, 2018

(54) PaaS CONNECTION METHOD AND PaaS CONNECTION DEVICE

(71) Applicant: FUJITSU LIMITED, Kawasaki-shi (JP)

(72) Inventor: Masahiro SATO, Yokohama (JP)

(73) Assignee: FUJITSU LIMITED, Kawasaki-shi (JP)

(21) Appl. No.: 15/693,658

(22) Filed: Sep. 1, 2017

(30) Foreign Application Priority Data
Nov. 16, 2016 (JP) 2016-223290

(51) Int. Cl. H04L 29/06; H04L 12/911; H04L 29/12

(52) U.S. Cl. CPC H04L 63/029; H04L 47/825; H04L 45/586; H04L 63/0236; H04L 63/0281; H04L 61/2585

(57) ABSTRACT

In a CF including an RN that executes an application, a GR that transfers a communication packet toward the application to the RN, and a GW that transfers a communication packet received by a tunnel to the GR, the GR is provided for each tenant. On receiving a communication packet from the tunnel that is set for each tenant, the GW transmits the communication packet to the GR associated with the tenant. On receiving the communication packet from the GW, the GR determines whether the URI of the destination is permitted and, when the URI is permitted, transmits the communication packet to the RN.

### CROSS-REFERENCE TO RELATED APPLICATION(S)

This application is based upon and claims the benefit of priority of the prior Japanese Patent Application No. 2016-223290, filed on Nov. 16, 2016, the entire contents of which are incorporated herein by reference.

### FIELD

The embodiments discussed herein are related to a PaaS connection method and a PaaS connection device.

### BACKGROUND

The use of Platform as a Service (PaaS) that provides information processing services on a public cloud connected to the Internet is increasing. FIG. 31 is a diagram for describing PaaS. As illustrated in FIG. 31, in PaaS, a user A and a user B are able to use APPLICATION#1, APPLICATION#2 and APPLICATION#3 that are applications on a public cloud via the Internet 9.

As the applications configured on PaaS are connected to the Internet 9, security measures in using the applications are important. FIG. 32 is a diagram illustrating an exemplary security threat. FIG. 32 illustrates the case where PaaS is realized by a cloud foundry (CP) 91. The CF 91 includes a PX 94, a GR 95, and a RN 96.

The PX 94 is a Proxy server that accepts an access using a uniform resource identifier (URI) to an application 962 in the CF 91 and transfers the accepted access to the GE 95.

The GR 95 is a GoRouter that identifies a host and a port from the URI by using an URI correspondence table 95b and transfers the access to the identified port of the host. The URI correspondence table 95b is a table in which a URI, an Internet protocol (IP) address of a host, and a port name are associated with one another. According to FIG. 32, the URI “app1.flab.com” is associated with the IP address “10.0.0.2” and the port name “1000”.

The RN 96 is a Runner that executes the application 962. The RN 96 includes a container 961. The container 961 is an environment in which the application 962 is executed and the container 961 has a port. According to FIG. 32, the application 962, for a tenant A, that is represented by APPLICATION#1 is executed in the container 961. APPLICATION#1 is accessed from the outside via the Internet 9 by using the URI “app1.flab.com”.

The PX 94, the GR 95, and the RN 96 are implemented by using virtual machines (VM). According to FIG. 32, the PX 94 is implemented by a VM represented by VM#3, the GR 95 is implemented toy a VM represented by VM#2, and the RN 96 is implemented by a VM represented by VM#1. The VMs may be implemented with different physical machines, respectively, all the VMs may be implemented with the same physical machine, or part of the VMs may be implemented with the same physical machine.

The network private IP address of the network in the CF 91 is “10.0.0.0/24”. The IP address of the RN 36 is “10.0.0.2”, the IP address of the GR 95 is “10.0.0.3”, and the IP address of the PX 94 is “10.0.0.4”.

A server 11 that is in on-premises 10 of a tenant A and that is represented by SERVER#1 accesses APPLICATION#1 via the Internet 9 by using the ORT. “app1.flab, com” . The “on-premises” denote information processing facilities that are managed and operated by the user.

The network private IF address in the on-premises 10 of the tenant A is “10.1.0.0/24” and the IP address of the server 11 is “10.1.0.2”. According to FIG. 32, the network private IP address in the on-premises 10 of the tenant B that is another tenant is “10.1.0.0/24” as well and the IP address of the server 11 “10.1.0.2” as well.

Communications between the server 11 and the CF 91 may be intercepted because the communications are via the Internet 9, In other words, communications interception or the Internet 9 is a security threat to PaaS.

The server 11 of the on-premises 10 of the tenant B is able to access APPLICATION#1 by identifying the URI “app1.flab.com” of APPLICATION#1. In other words, to PaaS, there is a security threat that the application 962 may fee accessed by other tenants.

For this reason, security measures are important to PaaS. For communications interception on the Internet 9, encryption is used as security measures. FIG. 33 is a diagram for explaining a method of encryption. As illustrated in FIG. 33, the on-premises 10 and the CF 91 are connected via a tunnel and communications through the tunnel are encrypted. For this reason, a GW 12 and a GW 93 for tunneling are configured in the on-premises 10 and the CF 91. According to FIG. 33, the GW 12 is represented by SERVER#2.

Accesses of tenants are limited for a security threat that the application 962 may be accessed by other tenants. FIG. 34 is a diagram for explaining a method of limiting accesses of tenants. As illustrated in FIG. 34, the GR 95 has a filtering table 95a. The filtering table 95a is a table in which a destination URI, a transmission source IP address, and a rule are associated with one another. The destination URI is an URI used to access the application 962, the transmission source IP address is the IP address of the source of the access to the application 962, and the rule indicates “permission” or “rejection”.

The GR 95 filters accesses by using the filtering table 95a. When the rule corresponding to the destination URI and the transmission source IP address (SA) contained in a received communication packet indicates “permission”, the GR 95 permits the access. When the rule indicates “rejection”, the GR 95 rejects the access. According to FIG. 34, the destination URI in the communication packet is “app1.flab.com”, the SA is “10.1.0.1” and the corresponding rule in the filtering table 95a indicates “permission” and thus the access is permitted.

There is another technology of providing hybrid application operations by transmitting a resource consumption request from an on-premises platform to a cloud resource and a response from the cloud resource to the on-premises platform via a secure tunnel.

There is still another technology of, by establishing a virtual network overlay between a data center and an enterprise private network, enabling secure connections between service application endpoints respectively resident in the data center and the enterprise private network.

Patent Document 1: Japanese Laid-open Patent Publication No. 2015-226322

Patent Document 2: Japanese Laid-open Patent Publication No. 2013-510506

The access limiting method illustrated in FIG. 34 has a problem in that, when the private IP addresses used in the on-premises of the respective tenants are the same, it is not possible to perform filtering correctly. FIG. 35 is a diagram for explaining the problem in the access limiting method illustrated in FIG. 34.

As illustrated in FIG. 35, both the server 11 of the tenant A and the server 11 of the tenant B have the IP address “10.1.0.2”, Thus, the transmission source IP addresses (SA) of communication packets received by the GE 95 are the same between the tenant A and the tenant B and thus the GR 95 is not able to perform filtering.

There is a method of limiting accesses of tenants other than the access limiting method illustrated in FIG. 34. FIG. 36 is a diagram for explaining another method of limiting accesses of tenants. As illustrated in FIG. 36, the transmission source adds a certificate to a communication packet and transmits the communication packet to the CF 91. The GR 95 is able to limit accesses by determining whether the access is permitted or rejected by using a filtering table 95c in which a destination URI, a certificate and a rule are associated with one another.

The access limiting method illustrated in FIG. 36 however has a disadvantage in that the costs of developing the CF application increase. The CF application is the application 962 that is executed, by the CF 91. FIG. 37 is a diagram for explaining the disadvantage of the access limiting method illustrated in FIG. 36. As illustrated in FIG. 37, in order to add a certificate to a communication packet, it is necessary to create and manage a certificate in each on-premises 10. Furthermore, the access method has to be changed, for example, such that a certificate is assigned in accessing the application 962.

### SUMMARY

According to an aspect of an embodiment, a non-transitory computer readable recording medium having stored therein a PaaS connection program enabling connection to an execution environment in which an application that provides services by PaaS, the PaaS connection program causing a computer to execute a process including on receiving data from a tunnel that is set for each tenant to which the application belongs, transferring the data to a transfer destination that is associated with the tunnel, and by the transfer destination, determining whether transferring the transferred data to the execution environment that is associated with a destination contained in the data is permitted and, when the transferring is permitted, transferring the data to the execution environment.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating a configuration of a CF according to a first embodiment;

FIG. 2 is a diagram for explaining sorting of communication packets performed by a GW;

FIG. 3 is a diagram for explaining filtering performed by a GR;

FIG. 4 is a diagram for explaining data transmission to on-premises performed by the GW;

FIG. 5 is a diagram for explaining secure connection made by a CF application;

FIG. 6 is a diagram for explaining a flow of converting an address in a communication packet (on-premises→CF);

FIG. 7A is a first diagram for explaining data processing on a communication packet (on-premises→CP);

FIG. 7B is a second diagram for explaining the data processing on a communication packet (on-premises→CF);

FIG. 8 is a diagram for explaining a flow of converting an address in a communication packet (return communication);

FIG. 9A is a first diagram for explaining data processing on a communication packet (return communication);

FIG. 9B is a second diagram for explaining the data processing on a communication packet (return communication);

FIG. 10 is a diagram illustrating a functional configuration of a manager;

FIG. 11A is a first flowchart illustrating a flow of process performed by the manager;

FIG. 11B is a second flowchart illustrating the flow of process performed by the manager;

FIG. 11C is a third flowchart illustrating the flow of process performed, by the manager;

FIG. 12 is a diagram illustrating an initial configuration;

FIG. 13 is a diagram illustrating a table configuration (initial configuration) in the manager;

FIG. 14 is a diagram for explaining allocation of an application;

FIG. 15 is a diagram illustrating the table configuration in the manager (after allocation of the application);

FIG. 16 is a diagram for explaining setting of a tunnel;

FIG. 17 is a diagram illustrating the table configuration in the manager (after setting of a tunnel);

FIG. 18 is a first diagram for explaining setting of a secure connection;

FIG. 19 is a diagram illustrating the table configuration in the manager (after setting of secure connection);

FIG. 20 is a second diagram for explaining setting of secure connection;

FIG. 21 is a diagram for explaining access of a tenant A to APPLICATION#1;

FIG. 22 is a diagram for explaining access of a tenant B to APPLICATION#1;

FIG. 23 is a diagram illustrating the state of the CF after configuring of the application and TUNNEL#1;

FIG. 24 is a diagram illustrating a table configuration in the manager (after setting of a tunnel);

FIG. 25 is a first diagram for explaining setting of secure connection according to a second embodiment;

FIG. 26 is a diagram illustrating a table configuration in the manager (after setting of secure connection);

FIG. 27 is a second diagram for explaining setting of secure connection according to the second embodiment;

FIG. 28 is a diagram for explaining access of the: tenant A to APPLICATION#1;

FIG. 29 is a diagram for explaining access of the tenant A to APPLICATION#1;

FIG. 30 is a diagram illustrating a hardware configuration of a computer that executes a VM;

FIG. 31 is a diagram for explaining PaaS;

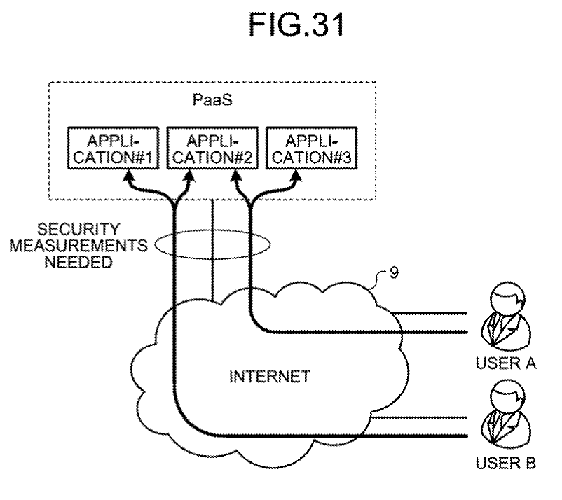

FIG. 32 is a diagram illustrating an exemplary security threat;

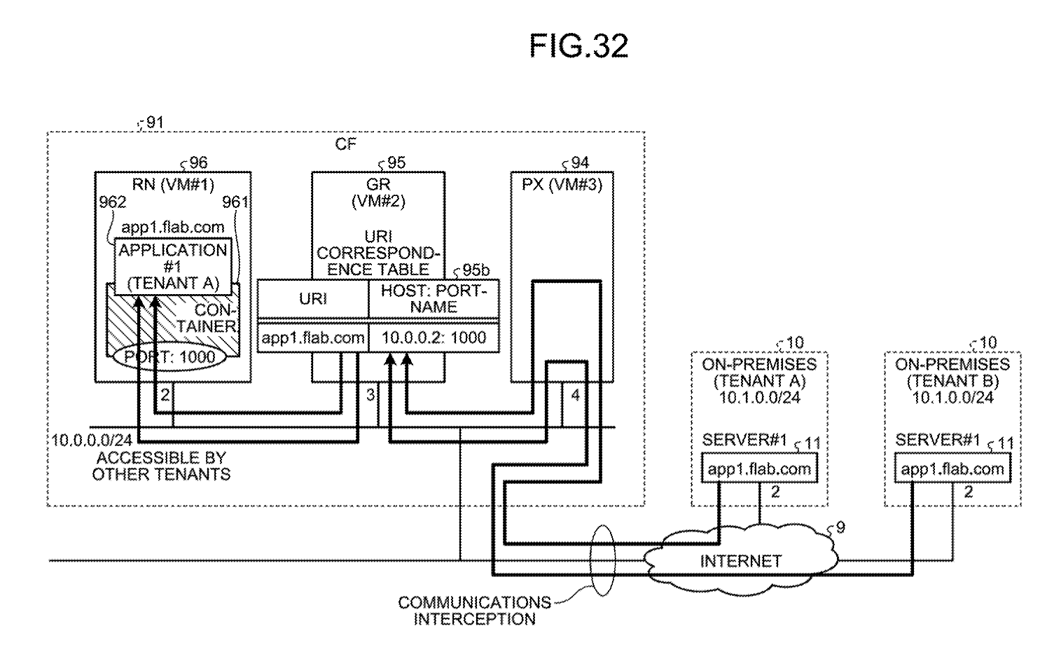

FIG. 33 is a diagram for explaining a method of encryption;

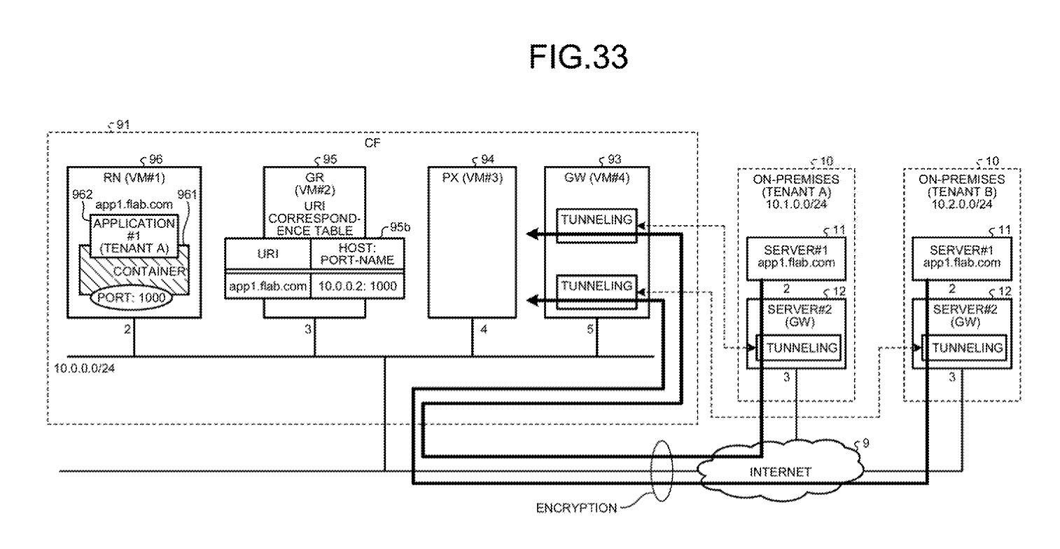

FIG. 34 is a diagram for explaining a method of limiting accesses of tenants;

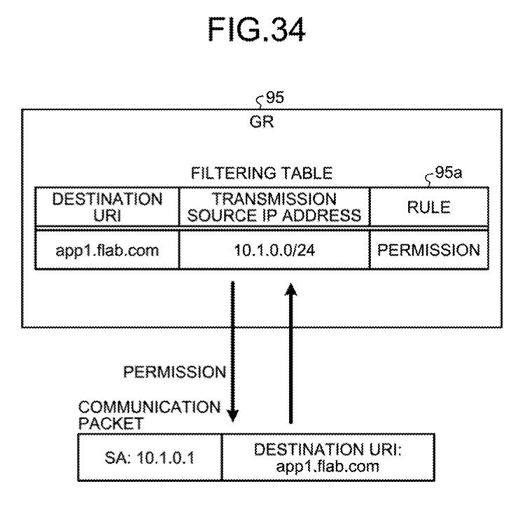

FIG. 35 is a diagram for explaining a problem in the access limiting method illustrated in FIG. 34;

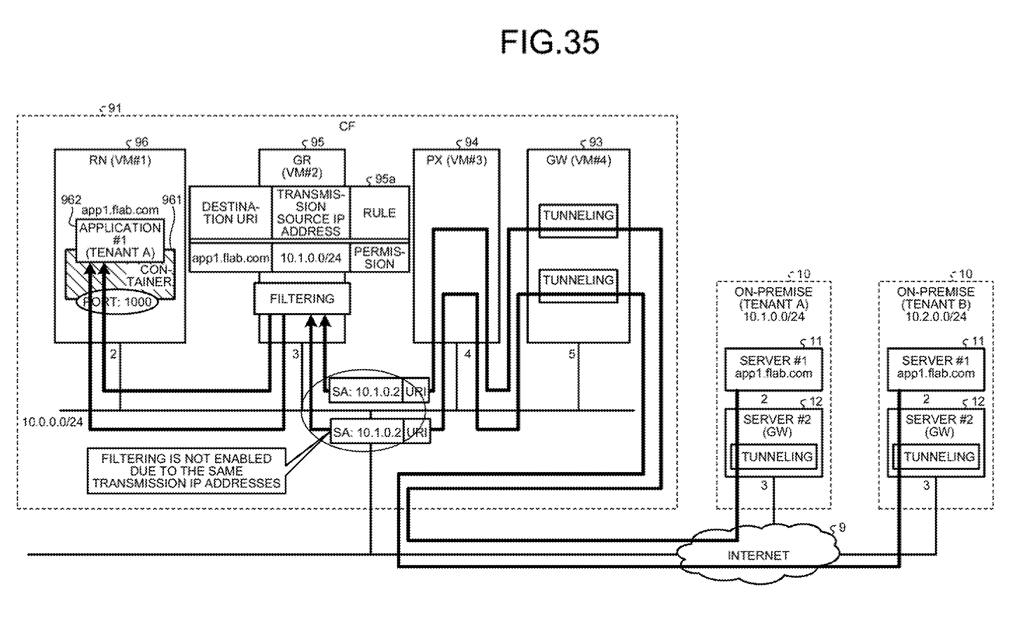

FIG. 36 is a diagram for explaining another method of limiting accesses of tenants; and

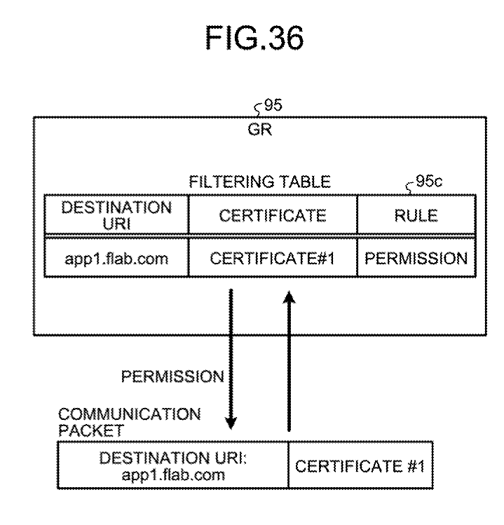

FIG. 37 is a diagram for explaining a disadvantage of the access limiting method illustrated in FIG. 36.

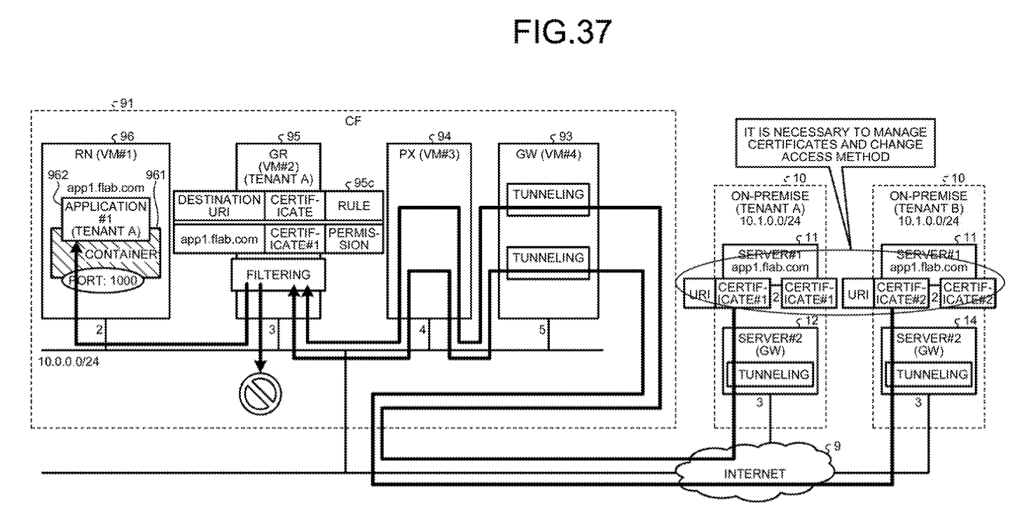

### DESCRIPTION OF EMBODIMENT(S)

Preferred embodiments of the present invention will be explained with reference to accompanying drawings. The embodiments do not limit the disclosed technology

### [a] First Embodiment

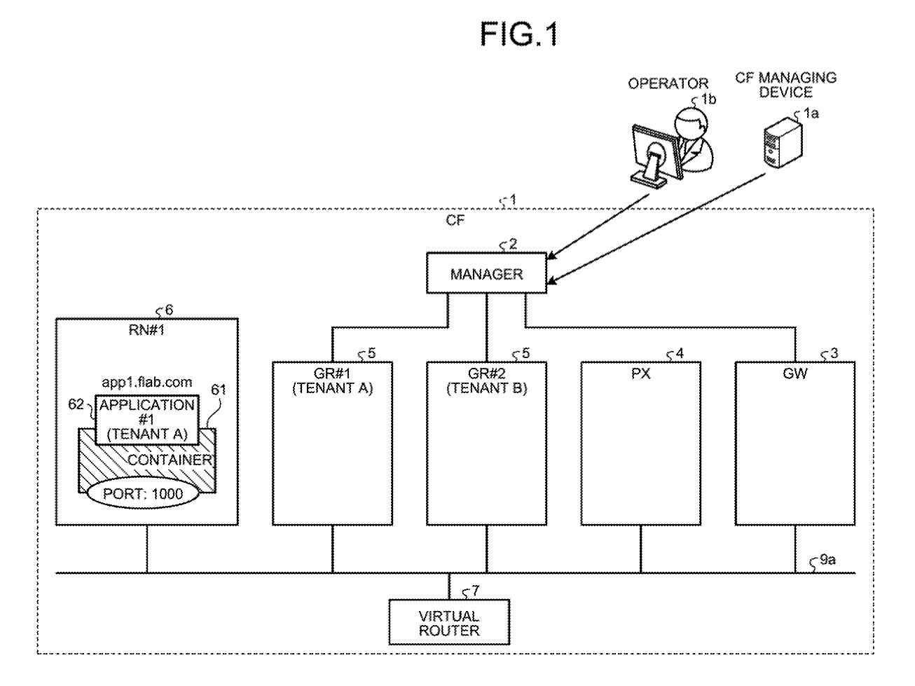

First of all, a configuration of a CF according to a first embodiment will be described. FIG. 1 is a diagram illustrating a configuration of a CF according to the first embodiment. As illustrated in FIG. 1, the CF 1 according to the first embodiment includes a manager 2, a GW 3, a PX 4, GRs 5 represented by GP#1 and GR#2, an RN 6 represented by RN#1, and a virtual router 7.

The manager 2 creates information of tables used by the GW 3 and the GR 5 according to a request of a CF managing device 1a that manages the CF 1 or by an operator 1b of the CF 1 and sets the information in the GW3 or the GR 5. The manager 2 manages the GRs 5 according to a request of the CF managing device 1a or the operator 1b of the CF 1. Details of the manager 2 will be described later.

The GW 3 performs processing relating to a tunnel that connects the CF 1 and on-premises, The GW 3 sorts a communication packet received from each tunnel between the CF1 and the on-premises to the corresponding GR 5. The GW 3 transmits a communication packet received from the GR 5 to a corresponding tunnel. The PX 4 is a Proxy server that communicates with the outside of the CF 1. Communication with an external environment that is connected via a tunnel is performed by the GW 3.

The GR 5 is a GoRouter that identifies a host and a port of a container 61 in which an application 62 runs from a URI contained in a communication packet and transfers the communication packet to the identified port of the host. On receiving a communication packet transmitted by the application 62 to the on-premises, the GR 5 transmits the communication packet to the GW 3. The GR 5 is provided for each tenant. FIG. 1 illustrates only GR#1 for the tenant A and GR#2 for the tenant B, and the number of GRs is the same as the number of tenants that are connected via tunnels.

The RN 6 is a Runner that executes the application 62. The RN 6 includes the container 61. The container 61 is an environment in which the application 62 is executed, and the container 61 has a port. The RN 6 receives a communication packet from the GR 5 and passes the communication packet to the application 62, and the RN 6 receives a communication packet from the application 62 and transmits the communication packet to the GR 5 corresponding to the tenant to which the application 62 belongs. APPLICATION#1 is the application 62 that belongs to the tenant A. APPLICATION#1 is accessed from the outside via the Internet by using the URI “app1.flab.com”.

The GW 3, the PX 4, the GR 5, the RN 6 and the manager 2 run on VMs. The VMs may run on different physical machines, respectively, all the VMs may run on the same single physical machine, or part of the VMs may run on the same physical machine.

The virtual router 7 transfers a communication packet that is received from the outside via the Internet to the PX 4 or the GW 3. The virtual router transmits a communication packet that is received from the PX 4 or the GW 3 to the outside via the Internet. The GW 3, the PX 4, GR#1, GR#2, the RN 6 and the virtual router 7 are connected with one another via a network 9a.

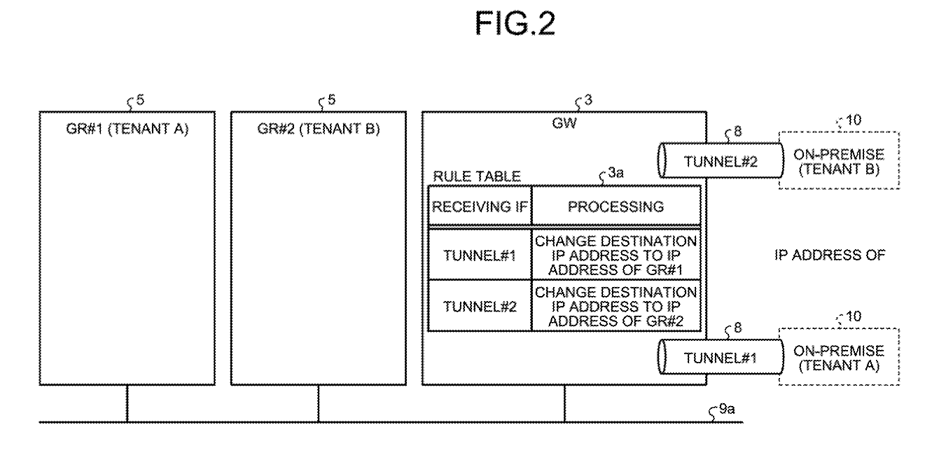

A PaaS connecting method according to the first embodiment will be described with reference to FIGS. 2 to 5. FIG. 2 is a diagram for explaining sorting of communication packets performed by the GW 3. As illustrated in FIG. 2, the GW 3 connects to on-premises 10 of the tenant A via a tunnel 8 represented by TUNNEL#1 and connects to the on-premises 10 of the tenant B via the tunnel 8 represented by TUNNEL#2.

The GW 3 has a rule table 3a. The rule table 3a is a table in which a receiving IF and processing are associated with each other. The receiving IF is the identifier of the tunnel 8 having received a communication packet. The processing indicates the processing or the communication packet received by the tunnel 8. Once the tunnel 8 receives a communication packet, the GW 3 refers to the rule table 3a and executes the processing associated with the tunnel 8. For example, once TUNNEL#1 receives a communication packet, the GW 3 changes the destination IP address in the communication packet to the IP address of GR#1 and transmits the communication packet to GR#1.

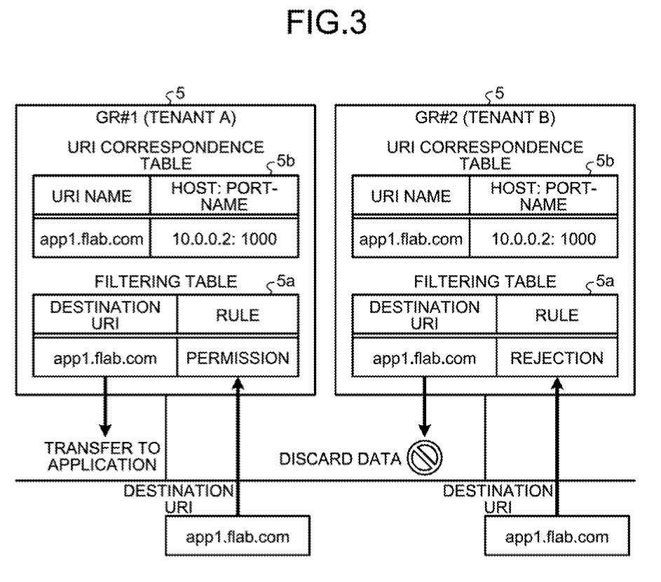

FIG. 3 is a diagram for explaining filtering performed by the GR 5. As illustrated in FIG. 3, the GR 5 has a filtering table 5a and a URI correspondence table 5b. The filtering table 5a is a table in which a destination URI and a rule are associated with each other. The destination URI indicates the destination of a communication packet. The rule indicates whether to permit or reject transferring the communication packet to the application 63. According to the filtering table 5a, the rule corresponding to the destination URI of the application 62 that belongs to the tenant of the GR 5 indicates “permission” and the rule corresponding to the destination URI of the application 62 that does not belong to the tenant of the GR 5 represents “rejection”.

On receiving a communication packet from the GW 3, the GR 5 refers to the filtering table 5a, determines whether transferring the communication packet is permitted and, when the transferring is permitted, transmits the communication packet to the RN 6. For example, when GR#1 receives a communication packet in which the destination. URI is “app1.flab.com”, GR#1 transmits the communication packet to the RN 6 as the transferring is permitted. On the other hand, when GR#2 receives a communication packet in which the destination URI is “app1.flab.com”, GR#2 discards the communication packet, as the transfer is rejected.

The URI correspondence table 5b is a table in which a URI name and host: port-name are associated with each other. The URI name is the URI used for access the application 62. The host is the IP address of the RN 6 that executes the application 62. The port name is the port number of the container 61 in which the application 62 runs.

When transferring the communication packet received from, the GW3 is permitted, the GR 5 identifies the IP address of the transfer destination and the port number o by using the URI correspondence table 5b and transfers the communication packet to the application 62 by using the identified IP address and port number. For example, GR#1 transfers the communication packet in which the destination URI is “app1.flab.com” to the container 61 in which the port number of the RN 6 whose IP address is “10.0.0.2” is “1000”.

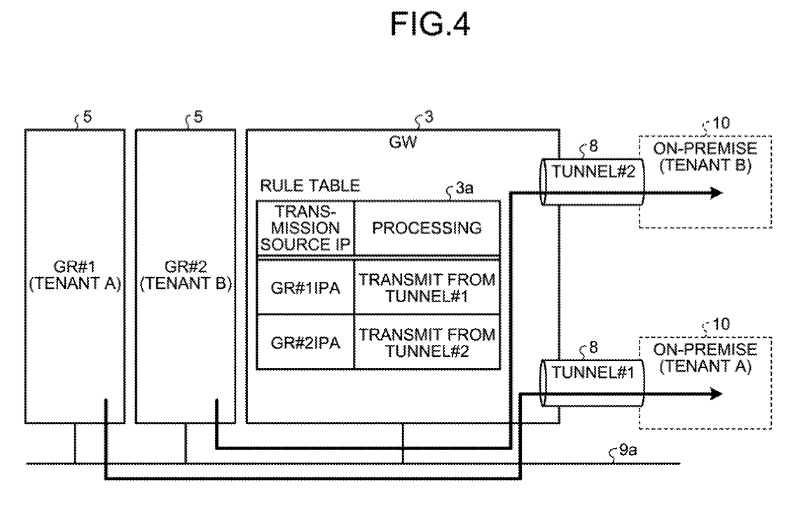

FIG. 4 is a diagram for explaining data transmission to the on-premises 10 performed by the GW3. As illustrated in FIG. 4, the GW 3 includes the rule table 3a. The rule table 3a illustrated in FIG. 4 is different from the rule table 3a in FIG. 2 in that the first column represents transmission source IPs. In other words, the first column of the rule table 3a represents receiving IFs or transmission source IPs. A transmission source IP is an IP address of the GR 5 from which a communication packet is transmitted.

On receiving the communication packet from the GR 1, the GW 3 refers to the rule table 3a and performs processing corresponding to the IP address of the GR 5 that is the transmission source. For example, on receiving a communication packet from GR#1, the GW 3 identifies processing corresponding to “GR#1IPA” that is the LP address of GE#1 and transmits the communication packet from TUNNEL#1.

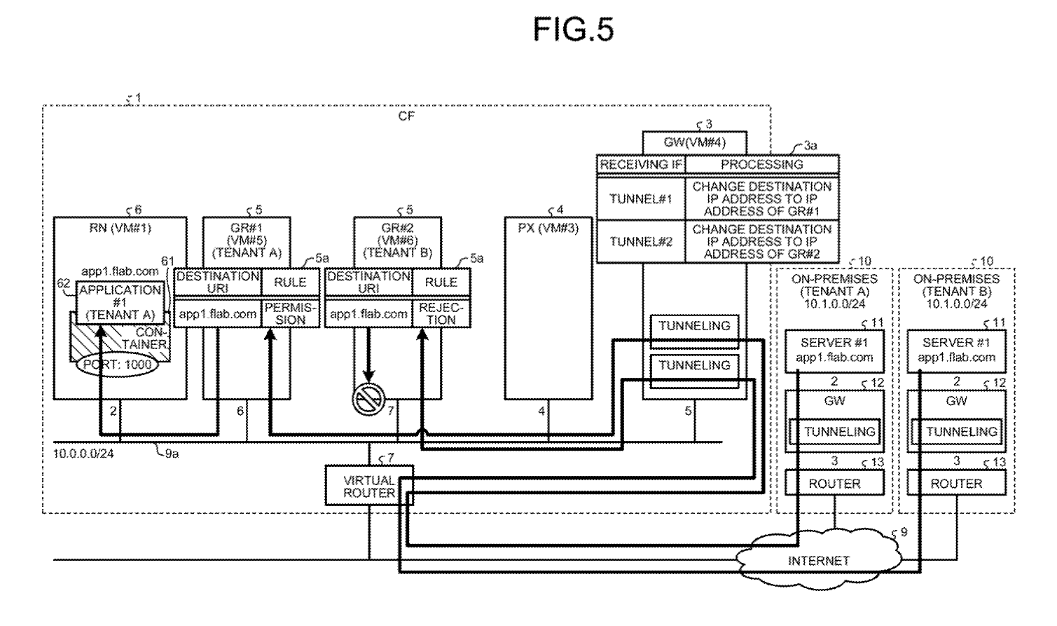

FIG. 5 is a diagram for explaining secure connection made by a CF application. As illustrated in FIG. 5, a communication packet that is transmitted toward APPLICATION#1 from SERVER#1 of the on-premises 10 of the tenant A is transferred to the GW 3 via the GW 12, a router 13, the Internet 9 and the virtual router 7. The communication packet is then transferred by the GW 3 to GR#1 and is transferred from GR#1 to the RN 6.

On the other hand, a communication packet that is transmitted toward APPLICATION#1 from SERVER#1 of the on-premises 10 of the tenant B is transferred to the GW 3 via the GW 12, the renter 13, the Internet 9, and the virtual renter 7, The communication packet is then transferred by the GW 3 to GR#2 and is discarded by GR#2.

As described above, the CF 1 holds the dedicated GR 5 for each tenant and the GW 3 transfers a communication packet to the GR 5 for the tenant corresponding to the tunnel 8 having received the communication packet. The GR 5 determines whether transfer of the communication packet is permitted or rejected with reference to the filtering table 5a. Accordingly, the PaaS connection according to the first embodiment does not need transmission source information in filtering and, even when the private IP addresses of the servers 11 overlap between tenants, only access of the server 11 of the tenant to which the application 62 belongs is permitted. Furthermore, Pass connection according to the first embodiment does not need any certificate and accordingly an increase in the development costs is not caused.

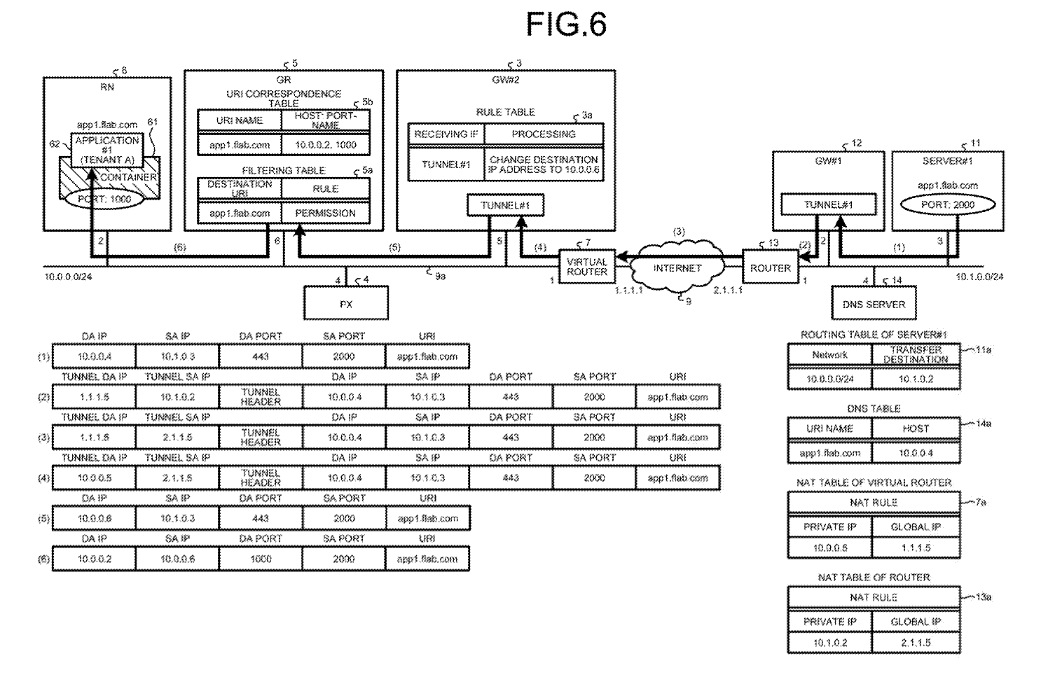

A flow of converting an address in a communication packet and its relevant processing will foe described with reference to FIGS. 6 to 9B. FIG. 6 is a diagram for explaining a flow of converting an address in a communication packet (the on-premises 10→the CF 1). As illustrated in FIG. 6, the private IP address of the on-premises 10 is “10.1.0.0/24”. The private IP address of SERVE#1 is “10.1.0.3” and the private IP address of GW#1 is “10.1.0.2”. The private IP address of the router 13 is “10.1.0.1” and the private IP address of a DNS server 14 is “10.1.0.4”.

The global IP address of the router 13 is “2.1.1.1” and the global IP address of the virtual router 7 is “1.1.1.1”. The global IP address of GW#2 is “1.1.1.5” as a NAT table 7a of the virtual router represents, and the global IP address of GW#1 is “2.1.1.5” as a NAT table 13a of the router 13 represents.

The private IP address of the CF I is “10.0.0.0/24”. The private IP address of the virtual boater 7 is “10.0.0.1”, the private IP address of GW#2 is “10.0.0.5”, and the private IP address of the GR 5 is “10.0.0.6”. The private IP address of the RN 6 is “10.0.0.2” and the private IP address of the PX4 is “10.0.0.4”.

An SA port is a port number of a source of transmission, a DA port is a port number of a transmission destination, SA IP is an IP address of the transmission source, and DA IP is an IP address of a destination of transmission.

As illustrated in FIG. 6, in a communication packet (1) that is transmitted from SERVER#1 to GW#1, SA. IP is the IP address “10.1.0.3” of SERVER#1. Furthermore, DA IP is the IP address “10.0.0.4” of the PX 4. The communication packet (1) is transmitted from SERVER#1 to GW#1 according to a routing table 11a of SERVER#1. The IP address “10.0.0.4” of the PX 4 is identified from the URI “app1.flab.com” according to a DNS table 14a of the DNS server 14.

In a communication packet (2) that is transmitted from GW#1 to the router 13, a tunnel header, a tunnel SA IP, and a tunnel DA IP are added by GW#1. The tunnel SA IP is the IP address “10.1.0.2” of GW#1. Furthermore, the tunnel DA IP is the global IP address “1.1.1.5” of GW#2.

In a communication packet (3) that is transmitted from the router 13 to the virtual router 7, the tunnel SA IP is converted by the rooter 13 into the global IP address “2.1.1.5” according to the NAT table 13a or the rooter 13.

In a communication packet (4) that is transmitted from the virtual router 7 to GW#2, the tunnel DA IP is converted by the virtual router 7 into the private IP address “10.0.0.5” according to the NAT table 7a of the virtual router 7.

In a communication packet (5) that is transmitted from GW#2 to the GR 5, the tunnel header, the tunnel SA IP, and the tunnel DA IP are removed by GW#2. The DA IP is converted by GW#2 into “10.0.0.6”.

In a communication packet (6) that is transmitted from the GR 5 to the RN 6, the DA IP is converted into “10.0.0.2”, the SA IP is converted into “10.0.0.6”, and the DA port is converted into “1000” by the GR 5.

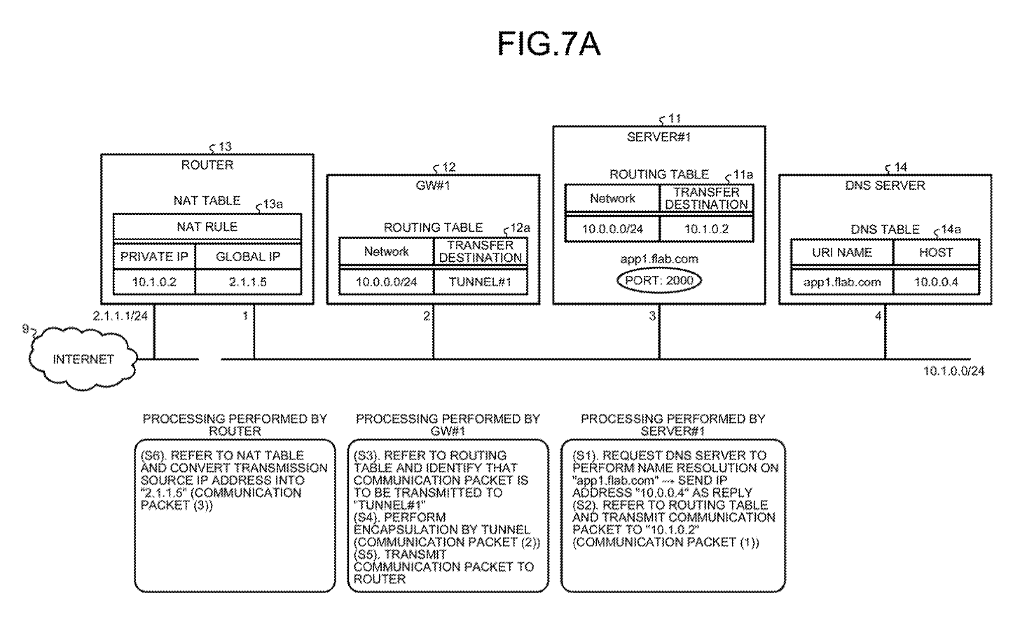

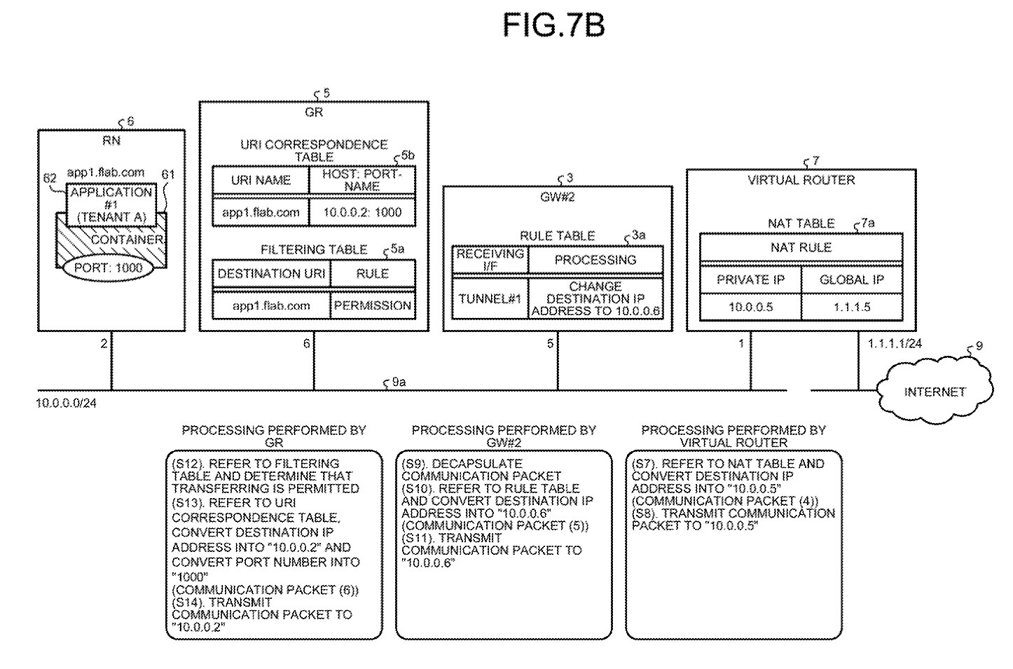

FIGS. 7A and 7B are diagrams for explaining data processing on a communication packet (the on-premises 10→the CF 1). As illustrated in FIG. 7A, SERVER#1 requests the DNS server 14 to perform name resolution on “app1.flab.com” and the DNS server 14 sends the IP address “10.0.0.4” as a reply (step S1). SERVER#1 then refers to the routing table 11a and transmits a communication packet to “10.1.0.2” (step S2). The communication packet to be transmitted is the communication packet represented in (1) in FIG. 6.

GW#1 having received the communication packet refers to a routing table 12a and identifies that the communication packet is transmitted to “TUNNEL#1” (step S3). GW#1 then encapsulates the communication packet by the tunnel 8 (step S4). The encapsulated communication packet is the packet illustrated in (2) in FIG. 6. GW#1 then transmits the communication packet to the router 13 (step S5).

The router 13 having received the communication packet refers to the NAT table 13a and converts the transmission source IP address into “2.1.1.5” (step S6). The converted communication packet is the communication packet illustrated in (3) FIG. 6. The router 13 transmits the communication packet to the virtual router 7.

As illustrated in FIG. 7B, the virtual router 7 having received the communication packet refers to the NAT table 7a and converts the destination IP address into “10.0.0.5” (step S7). The converted communication packet is the communication packet illustrated in (4) in FIG. 6. The virtual router transmits the communication packet to “10.0.0.5” (step S8).

GW#2 having received the communication packet decapsulates the communication packet (step S9). then refers to the rule table 3a and converts the destination IP address into “10.0.0.6” (step S10). The converted communication packet is the communication packet illustrated in (5) in FIG. 6. GW#2 transmits the communication packet to “10.0.0.6” (step S11).

The GR 5 having received the communication packet refers to the filtering table 5a and determines that transferring the communication packet is permitted (step S12). The GR 5 refers to the URI correspondence table 5b and converts the destination IP address into “10.0.0.2” and converts the port number into “1000” (step S13). The converted communication packet is the communication packet illustrated in (6) in FIG. 6. The GR 5 transmits the communication packet to “10.0.0.2” (step S14).

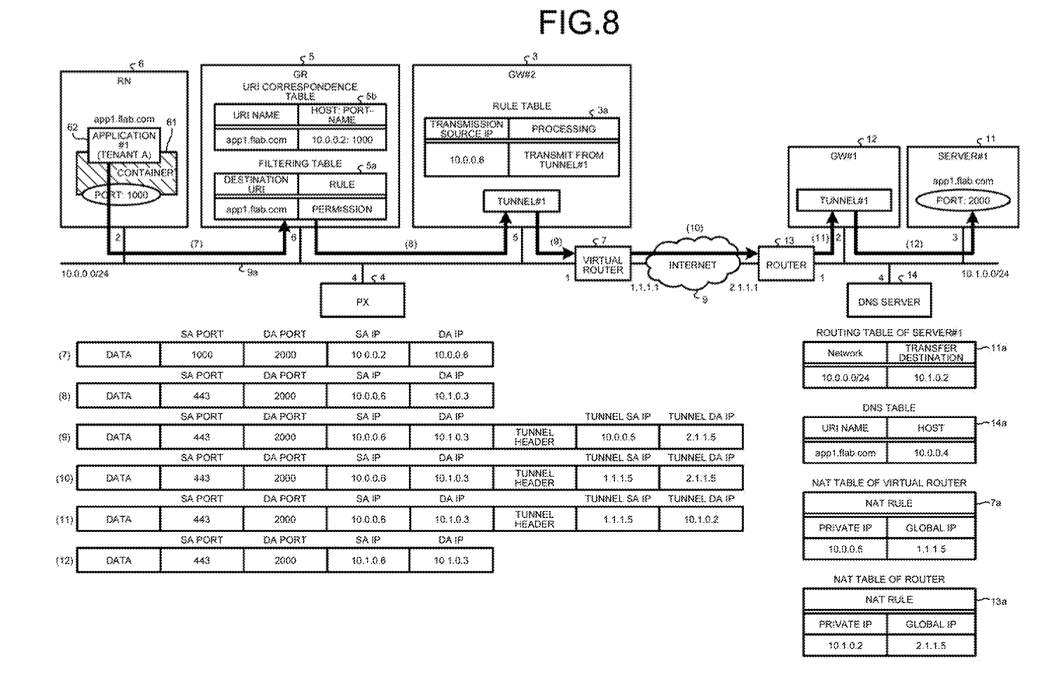

FIG. 8 is a diagram for explaining a flow of converting an address in a communication packet (return communication). As illustrated in FIG. 8, in the communication packet (7) transmitted from the RN 6 to the GR 5, the SA IP is the IP address “10.0.0.2” of the RN 6. Furthermore, the DA IP is the IP address “10.0.0.6” of the GR 5.

In the communication, packet (9) transmitted from the GR 5 to GW#2, the SA IP is converted into “10.0.0.6” and the DA IP is converted into “10.1.0.3” of SERVER#1, and the SA port is converted into “443” by the GR 5.

To the communication packet (9) transmitted from the GW#2 to the virtual router 7, a tunnel header, a tunnel SA IP, and a tunnel DA IP are added by GW#2. The tunnel SA IP is the IP address “10.0.0.5” of GM#2. Furthermore, the tunnel DA IP is the global IP address “2.1.1.5” of GW#1.

In the communication packet (10) transmitted from the virtual router 7 to the router 13, the tunnel SA IP is converted by the virtual router 7 into the global IP address “1.1.1.5” of the virtual router 7 according to the NAT table 7a of the virtual router 7.

In the communication packet (11) transmitted from the router 13 to GW#1, the tunnel header, the tunnel DA IP is converted by the router 13 into the private IP address “10.1.0.2” of GW#1 according to the NAT table 13a of the router 13.

In the communication packet (12) transmitted from GW#1 to SERVER#1, the tunnel header, the tunnel SA IP, and the tunnel DA IP are removed by GW#1.

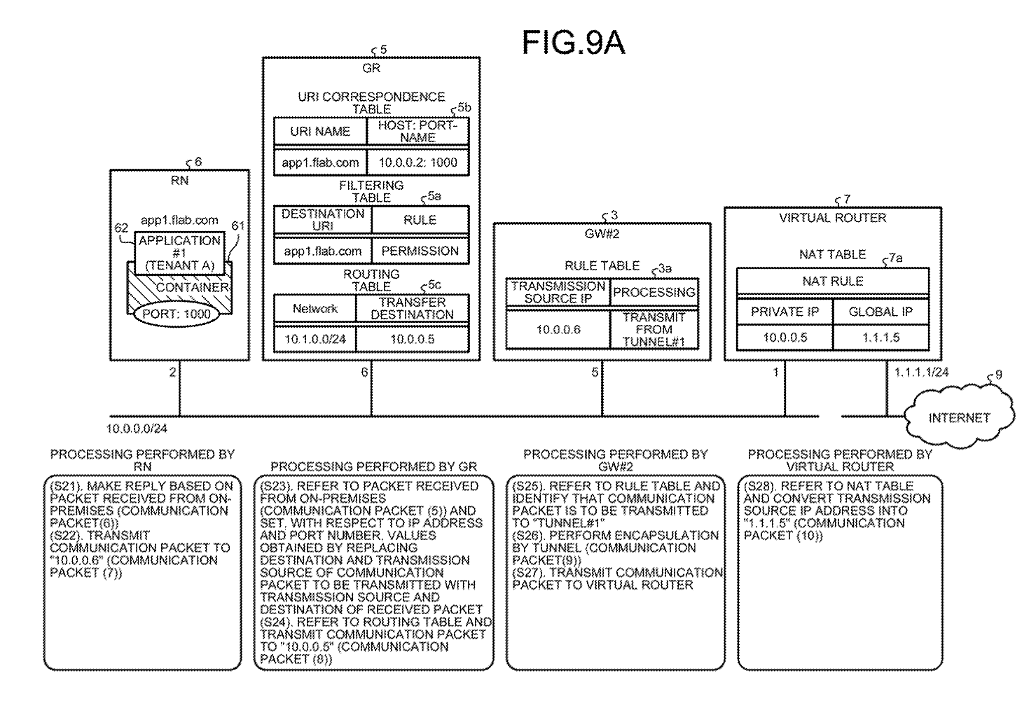

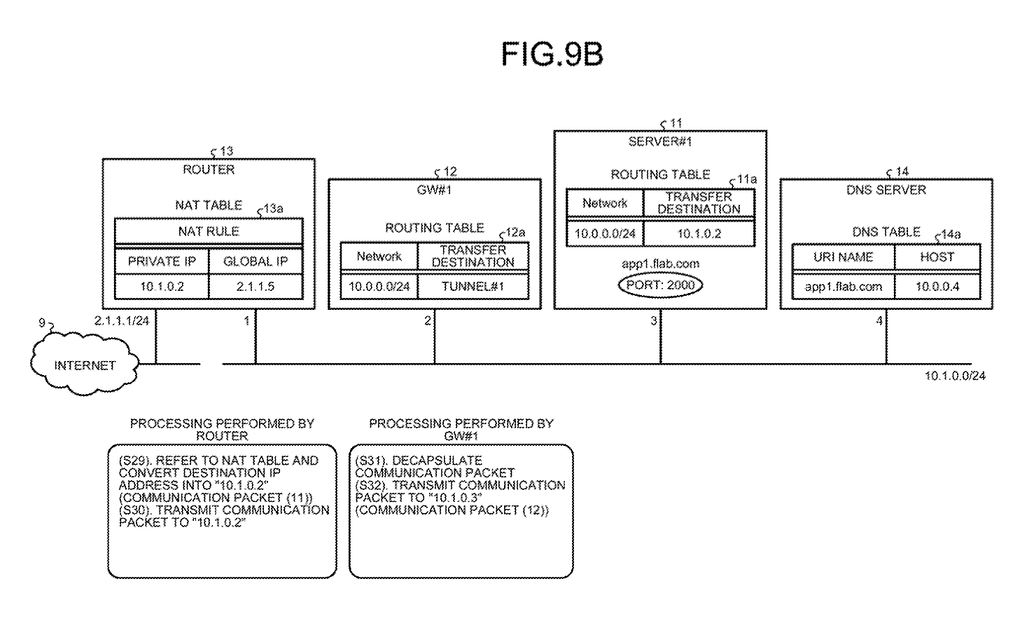

FIGS. 9A and 9B are diagrams for explaining data processing (return communication) on the communication packet. As illustrated in FIG. 9A, APPLICATION#1 replies based on the received packet (the communication packet (6)) from the on-premises 10 (step S21). The RN 6 transmits the communication packet sent by APPLICATION#1 as a reply to “10.0.0.6” (step S32). The transmitted communication packet is the communication packet illustrated in (7) in FIG. 8.

The GR 5 having received the communication packet refers to the information of the received packet (the communication packet (5)) and, with respect to the IP address and the port number, sets values obtained by replacing the destination and the transmission source of the communication packet to be transmitted with the transmission source and the destination of the received packet (step S23). This operation is the operation that is normally performed by the GR 5. The GR 5 refers to a routing table 5c and transmits the communication packet to “10.0.0.5” (step S24). The transmitted communication packet is the communication packet illustrated in (8) in FIG. 8.

GW#2 having received the communication packet refers to the rule table 3a and identifies that the transmission packet is to be transmitted to “TUNNEL#1” (step S25). GW#2 then encapsulates the communication packet by the tunnel 8 (step S26). The encapsulated communication packet is the communication packet illustrated in (9) in FIG. 8. GW#2 then transmits the communication packet to the virtual router 7 (step S27).

The virtual router 7 having received the communication packet refers to the NAT table 7a and converts the transmission source IP address into “1.1.1.5” (step S28). The converted communication packet is the communication packet illustrated in (10) in FIG. 8.

As illustrated in FIG. 9B, the router 13 having received the communication packet refers to the NAT table 13a and converts the destination IP address into “10.1.0.2” (step S29). The converted communication packet is the communication packet illustrated in (11) in FIG. 8. The router 13 transmits the communication packet to “10.1.0.2”(step S30).

GW#1 having received the communication packet decapsulates the data (step S31) and transmits the communication packet to “10.1.0.3” (step S32). The transmitted communication packet is the communication packet illustrated in (12) in FIG. 8.

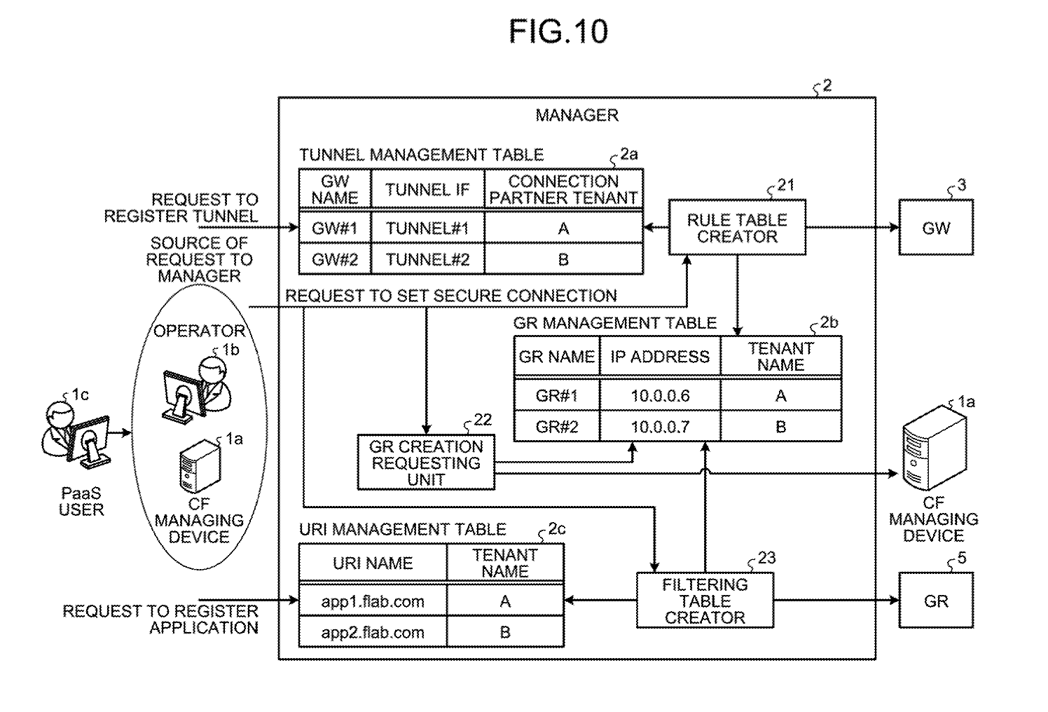

The functional configuration of the manager 2 will be described. FIG. 10 is a diagram illustrating a functional configuration of the manager 2. As illustrated in FIG. 10, the manager 2 includes a tunnel management table 2a, a GR management table 2b, and a URI management table 2c. The tunnel management table 2a, the GR management table 2b, and the URI management table 2c are stored in a storage unit of the manager 2. The manager 2 further includes a rule table creator 21, a GR creation requesting unit 22, and a filtering table creator 23.

The tunnel management table 2a is a table for managing the tunnels 8. As illustrated in FIG. 10, in the tunnel management table 2a, a GW name, a tunnel IF, and a connection partner tenant are associated with each tunnel 8. The GW name is the name that identifies the GW 3 that performs tunnel processing. The tunnel IF is the name that identifies the tunnel 8. The connection partner tenant is the name of the tenant that connects to the tunnel 8. For example, tunnel processing is performed by the GW 3 whose name is “GW#1” in the tunnel 8 whose name is “TUNNEL#1” and the tunnel 8 connects to the tenant whose name is “A”.

The manager 2 registers information about the tunnel 8 in the tunnel management table 2a according to a tunnel registration request from the CF managing device 1a or the operator 1b. The CF managing device 1a and the operator 1b request the manager 2 to register the tunnel B according to a request of a PaaS user 1c.

The GR management table 2b is a table for managing the GRs 5. As illustrated in FIG. 10, in the GR management table 2b, a GR name, an IP address, and a tenant name are associated with each GR 5. The GR name is the name that identifies the GR 5. The IP address is the IP address of the GR 5. The tenant name is the name of the tenant that performs communication by using the communication packet that is processed by the GR 5. For example, the GR 5 whose name is “GR#1” processes the communication packet of the tenant whose IP address is “10.0.0.6” and whose name is “A”.

The URI management table 2c is a table that manages URIs used to access the application 62 on the CF 1. As illustrated in FIG. 10, in the URI management table 2c, an URI name and a tenant name are associated with each URI used to access the application 62 on the CF 1. The URI name is the name of a URI used to access the application 62 on the CF 1. The tenant name is the name of a tenant to which the application 62 on the CF 1 belongs. For example, the application 62 accessed by the URI name “app1.flab.com” belongs to the tenant whose name is “A”.

The manager 2 registers information about a URI in the URI management table 2c according to an application registration request from the CF managing device 1a or the operator 1b. The CF managing device 1a and the operator 1b request the manager 2 to register an application according to a request of the PaaS user 1c.

The rule table creator 21 creates information of the rule table 3a by using the tunnel management table 2a and the GR management table 2b according to a secure connection setting request from the CF managing device la or the operator 1b and sets the information in the rule table 3a of the GW 3.

The GR creation requesting unit 22 requests the CF managing device 1a to create the GR 5 according to a secure connection setting request from the CF managing device 1a or the operator 1b and updates the GR management table 2b according to information about the created GR 5.

The filtering table creator 23 creates information of the filtering table 5a by using the URI management table 2c and the GR management table 2b according to a secure connection setting request from the CF managing device 1a or the operator 1b. The filtering table creator 23 sets the created information in the filtering table 5a.

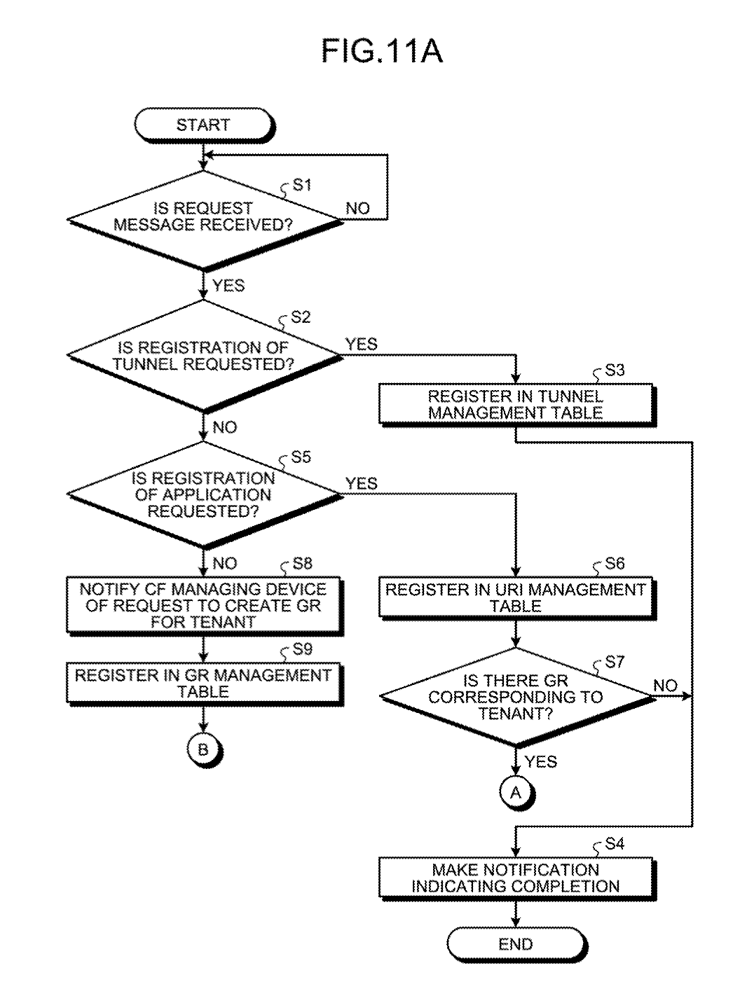

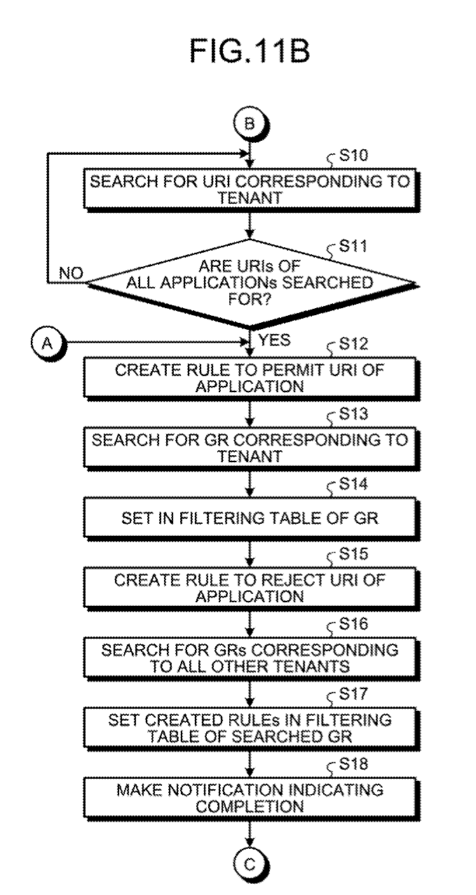

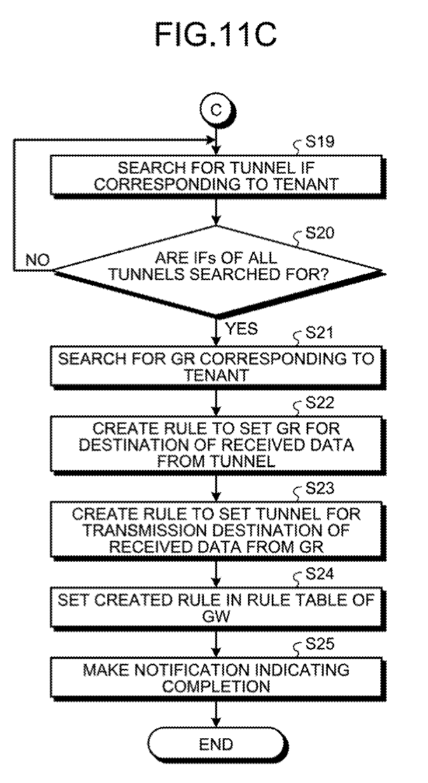

A flow of the process performed by the manager 2 will be described. FIGS. 11A to 11C are flowcharts illustrating the flow of the process performed by the manager 2. As illustrated in FIG. 11A, the manager 2 determines whether a request message is received from the CF managing device 1a or the operator 1b (step S1) and waits until receiving a request message.

On receiving a request message, the manager 2 determines whether the request message is a tunnel registration request (step S2), When the request message is a tunnel registration request, the manager 2 registers information about the tunnel 8 in the tunnel management table 2a (step S3) and notifies the CF managing device 1a or the operator 1b of completion (step S4).

On the other hand, when the request message is not a tunnel registration request, the manager 2 determines whether the request message is an application registration request (step S5). When the request message is an application registration request, the manager 2 registers information about a URI that is used to access the application 62 in the URI management table 2c (step S6).

The manager 2 then determines whether there is the GR 5 corresponding to the tenant (step S7). When there is not the GR 5, secure connection to the tenant has not been set and thus the manager 2 notifies the CF managing device 1a or the operator 1b of completion (step S4). On the other hand, when there is the GR 5 corresponding to the tenant, secure connection to the tenant has been set and thus the manager 2 goes to step S12.

When the request message is not an application registration request, the request message is a secure connection setting request and thus the GR creation requesting unit 22 of the manager 2 notifies the CF managing device 1a of a request to create the GR 5 for the tenant (step S8) and registers information about the created GR 5 in the GR management table 2b (step S9).

As illustrated in FIG. 11B, the filtering table creator 23 of the manager 2 searches for the URI of the application 62 corresponding to the tenant from the URI management table 2c (step S10) and determines whether the URIs of all the applications 62 have been searched for (step S11). When there is a URI that is not searched for, the filtering table creator 23 goes back to step S10.

On the other hand, when the URIs of all the applications 62 have been searched for, with respect to all the searched URIs, the filtering table creator 23 creates a rule indicating that the URI of the application 62 is permitted (step S12) and searches for the GR 5 corresponding to the tenant (step S13). The filtering table creator 2 then sets the created rules in the filtering table 5a of the GR 5 (step S14).

The filtering table creator 23 creates, with respect to all the searched URIs, a rule indicating that the URI of the application 62 is rejected (step S15) and searches for the GRs 5 corresponding to all other tenants (step S16). The filtering table creator 23 then sets the created rules in the filtering table 5a of the GR 5 that is searched for (step S17). The sets of processing at steps S12 to S14 and steps S15 to S17 may be in an inverse order. The manager 2 notifies the CF managing device 1a or the operator 1b of completion (step S18).

As illustrated in FIG. 11C, the rule table creator 21 of the manager 2 then searches for the tunnel IF corresponding to the tenant from the tunnel management table 2a (step S19) and determines whether all the tunnel IFs have been searched for (step S20). When there is a tunnel IF that, has not been searched for, the rule table creator 21 goes back to step S19.

On the other hand, when all the tunnel IFs have been searched for, the rule table creator 21 searches for the GR 5 corresponding to the tenant from the GR management table 2b (step S21). The rule table creator 21 then, with respect to all the tunnel IFs, creates a rule indicating that the GR 5 is set for the destination of the data received frost the tunnel 8 (step S22) and creates a rule indicating that the tunnel 8 is set for the destination to which the data received from the GR 5 is transmitted (step S23).

The rule table creator 21 then sets the created rules in the rule table 3a of the GW 3 (step S24) and notifies the CF managing device 1a or the operator 1b of completion (step S25).

In this manner, the filtering table creator 23 creates a filtering rule and sets the rule in the filtering table 5a of the GR 5 and the rule table creator 21 creates a rule about the tunnel 8 and the GR 5 and sets the rule in the rule table 3a of the GW 3. Accordingly, the CF 1 is able to prevent access to the application 62 from tenants other than the tenant to which the application 62 belongs.

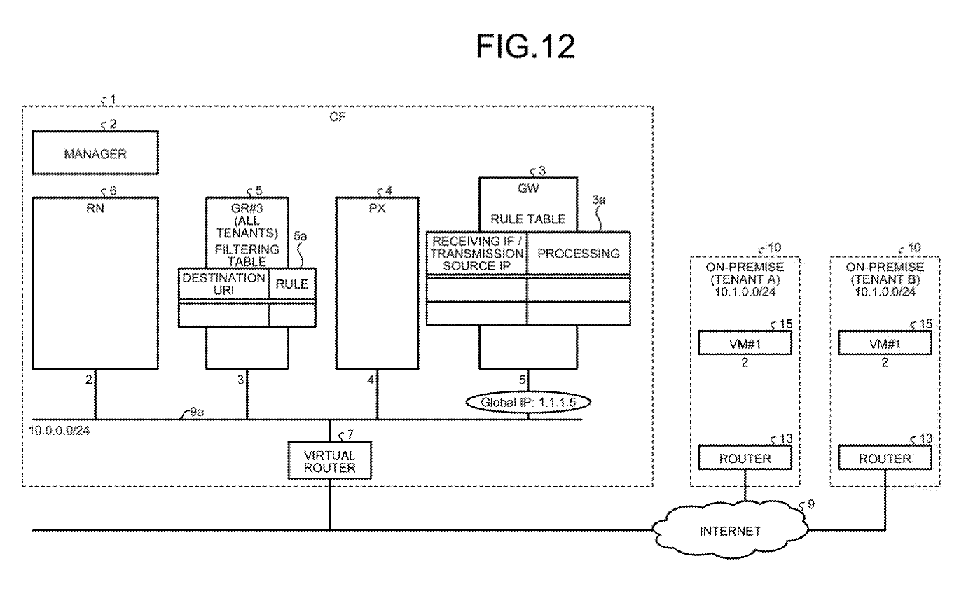

Exemplary PaaS connection performed by the CF 1 will be described with reference to FIGS. 12 to 22. FIG. 12 is a diagram illustrating an initial configuration. As illustrated in FIG. 12, in the initial configuration, the CF 1 includes the manager 2, the GW 3, the PX 4, GR#3, the RN 6, and the virtual router 7. GR#3 is the GR 5 common to all the tenants excluding the tenant that performs secure connection. No information is registered in the rule table 3a of the GW 3 and the filtering table 5a of GR#3. A VM 15 represented by VM#1 runs in the on-premises 10 of the tenant A and the on-premises 10 of the tenant B.

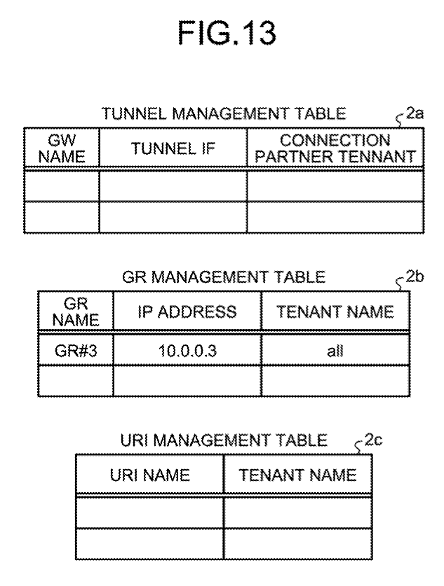

FIG. 13 is a diagram illustrating a table configuration (initial configuration) in the manager 2. As illustrated in FIG. 13, no information is registered in the tunnel management table 2a and the URI management table 2c. Only information about GR#3 is registered in the GR management table 2b. “all” in FIG. 13 indicates all the tenants excluding the tenant that performs secure connection.

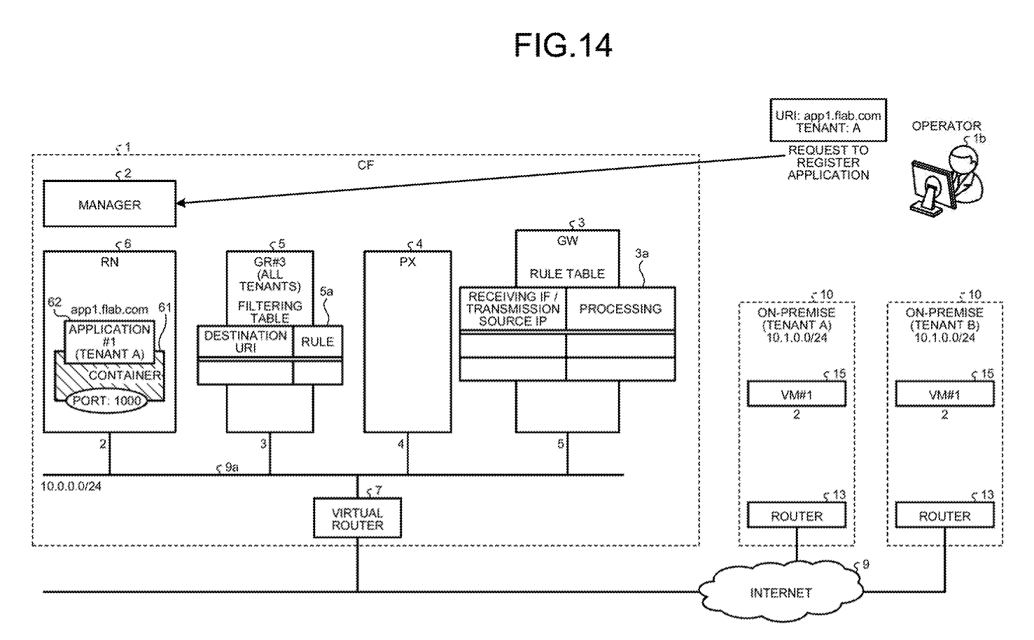

First of all, the application 62 is allocated in the RN 6. FIG. 14 is a diagram for explaining allocation of the application 62. As illustrated in FIG. 14, APPLICATION#1 is allocated in the RN 6 and the manager 2 is notified of an application registration request. The application registration request contains the tenant name “A” and the URI “app1.flab.com” of APPLICATION#1.

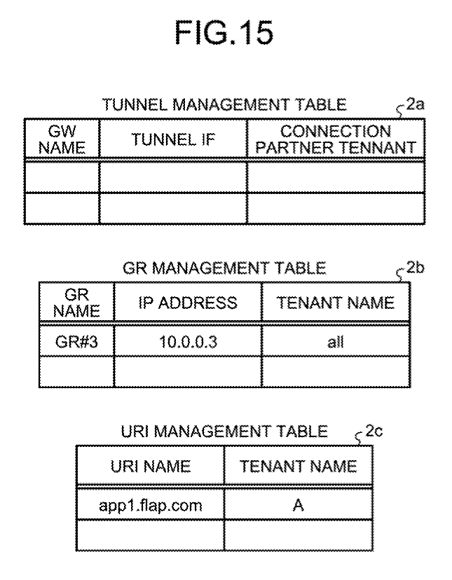

The manager 2 then updates the URI management table 2c. FIG. 15 is a diagram illustrating the table configuration in the manager 2 (after allocation of the application 62). As illustrated in FIG. 15, the URI name “app1.flab.com” and the tenant name “A” of APPLICATION#1 are registered in the URI management table 2c after the update.

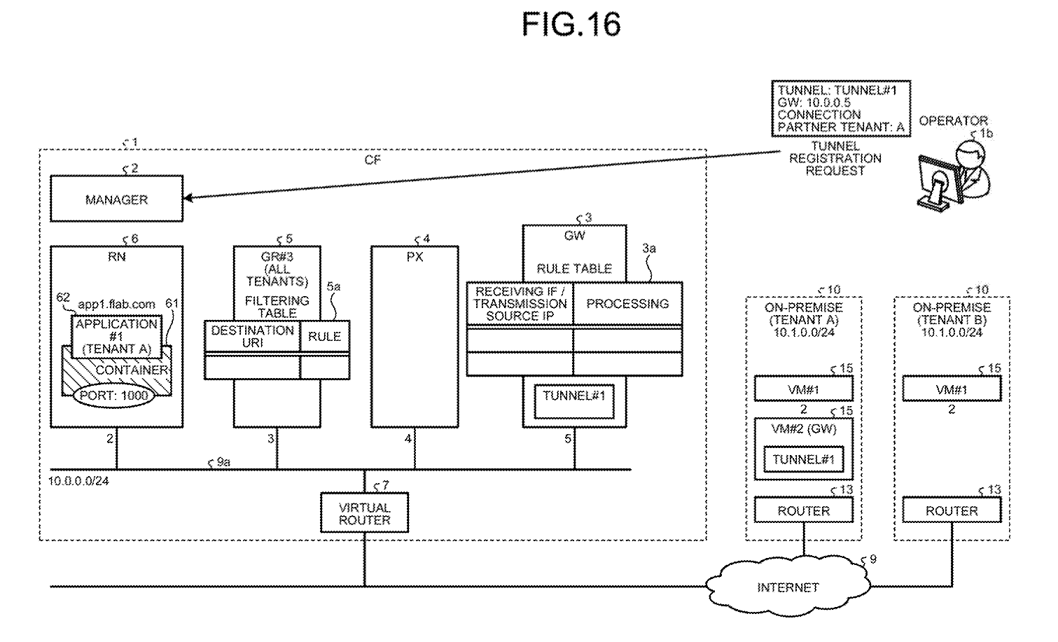

The tunnel 8 is then set. FIG. 16 is a diagram for explaining setting of a tunnel. When the tunnel 8 is set between the on-premises 10 and the CF 1, the manager 2 is notified of a tunnel registration request as illustrated in FIG. 16. The tunnel registration request contains the tunnel name “TUNNEL#1”, the GW name “10.0.0.5” and the connection partner tenant “A”.

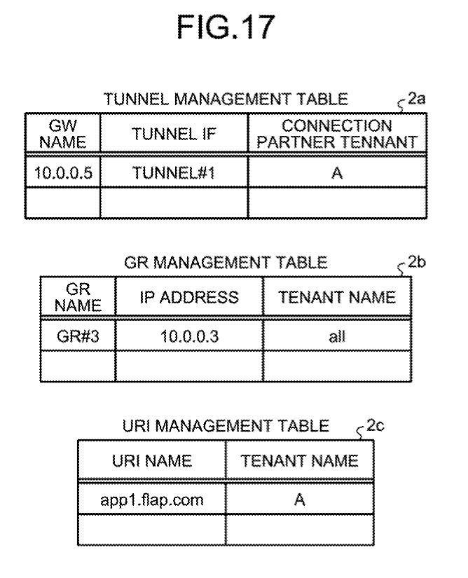

The manager 2 then updates the tunnel management table 2a. FIG. 17 is a diagram illustrating the table configuration in the manager 2 (after setting of the tunnel 8). As illustrated in FIG. 17, with respect to the set tunnel 8, the GW name “10.0.0.5”, the tunnel IF “TUNNEL#1” and the correction partner tenant “A” are registered in the updated tunnel management table 2a. The GW name is the IP address of the GW 3. The VM 15 for GW is generated as VM#2 in the on-premises 10.

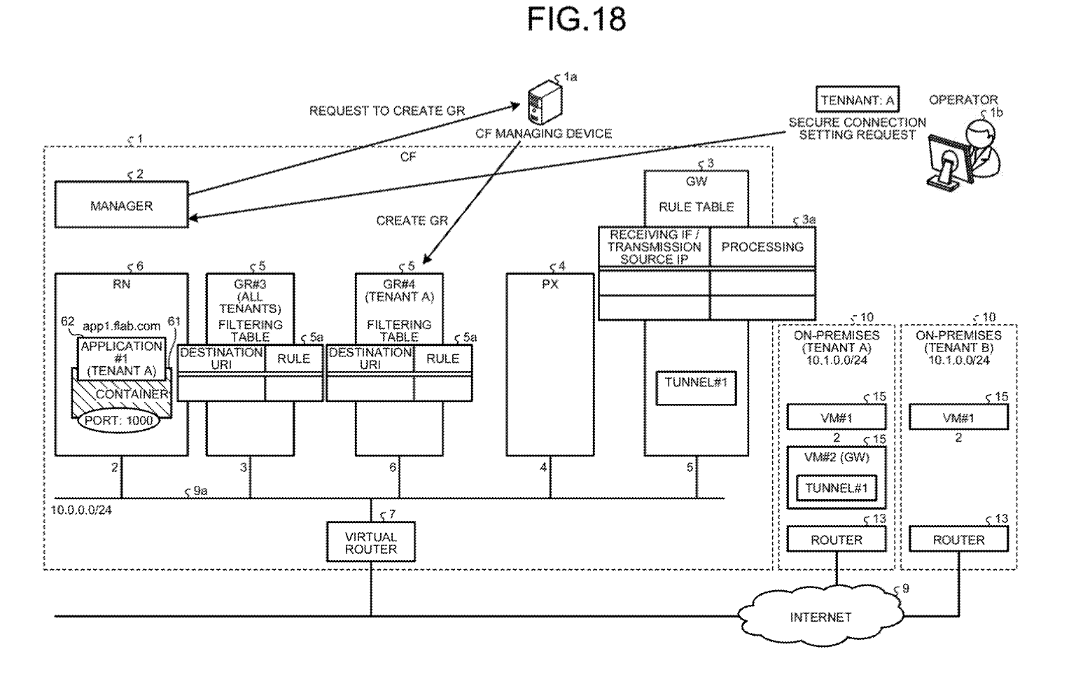

Secure connection is then set. FIG. 18 is a first diagram for explaining setting of secure connection. As illustrated in FIG. 18, the manager 2 is notified of a secure connection setting request. The secure connection setting request contains the tenant name “A”. The manager 2 then requests the CF managing device 1a to create the GR 5. The GR 5 represented by GR#4 is then created. The manager 2 updates the GR management table 2b by using the information about GR#4 that is created.

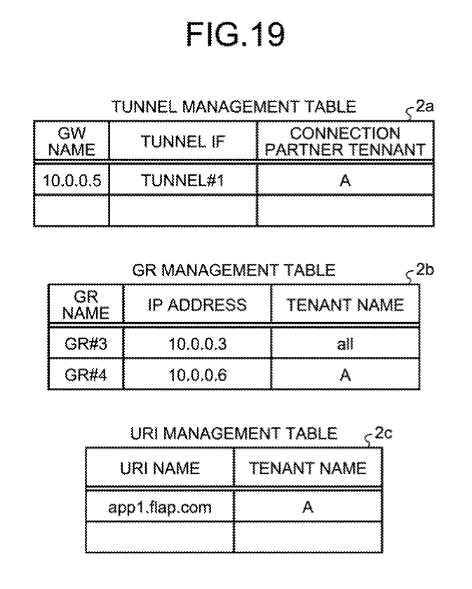

FIG. 19 is a diagram illustrating the table configuration in the manager 2 (after setting of secure connection). As illustrated in FIG. 19, the GR name “GR#1”, the IP address “10.0.0.6” and the tenant name “A”, are registered in the updated GR management table 2b.

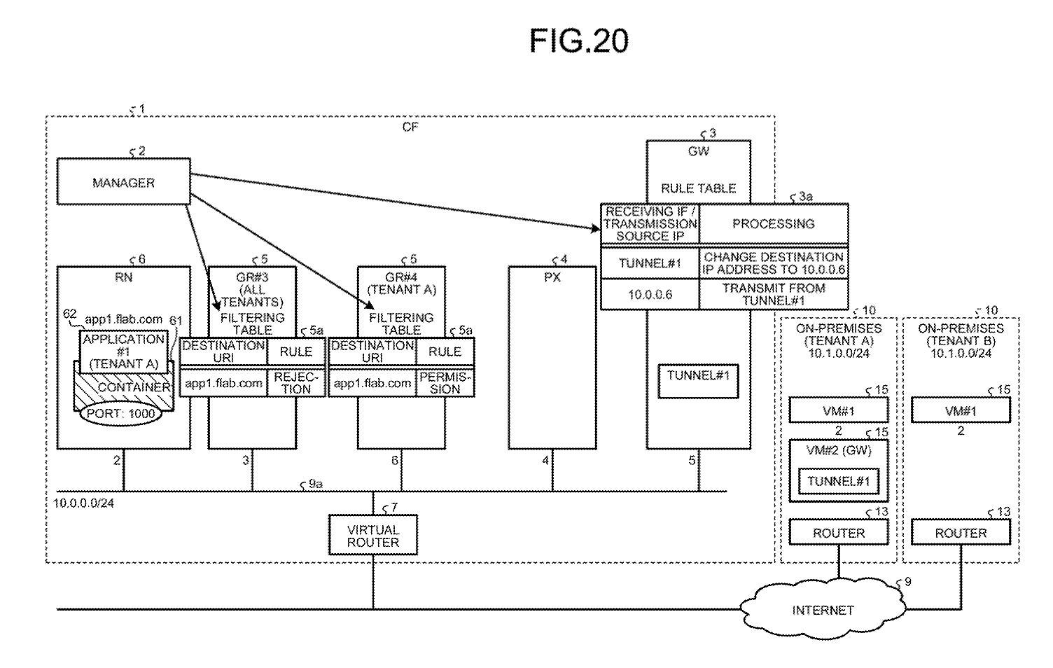

FIG. 20 is a second diagram for explaining setting of secure connection. As illustrated in FIG. 20, the manager 2 sets the filtering table 5a of GR#4. In the filtering table 5a of GR#4, “PERMISSION” is registered in association with the destination URI “app1.flab.com”. The manager 2 sets the filtering table 5a of GR#3. in the filtering table 5a of GR#3, “REJECTION” is registered in association with the destination URI “app1.flab.com”,

The manager 2 then sets the rule table 3a of the GW 3. In the rule table 3a of the GW 3, the processing of changing the destination IP address in the communication packet received from TUNNEL#1 to “10.0.0.6” is registered in association with TUNNEL#1 and the processing of transmission from TUNNEL#1 is registered in association with the IP address of GR#4.

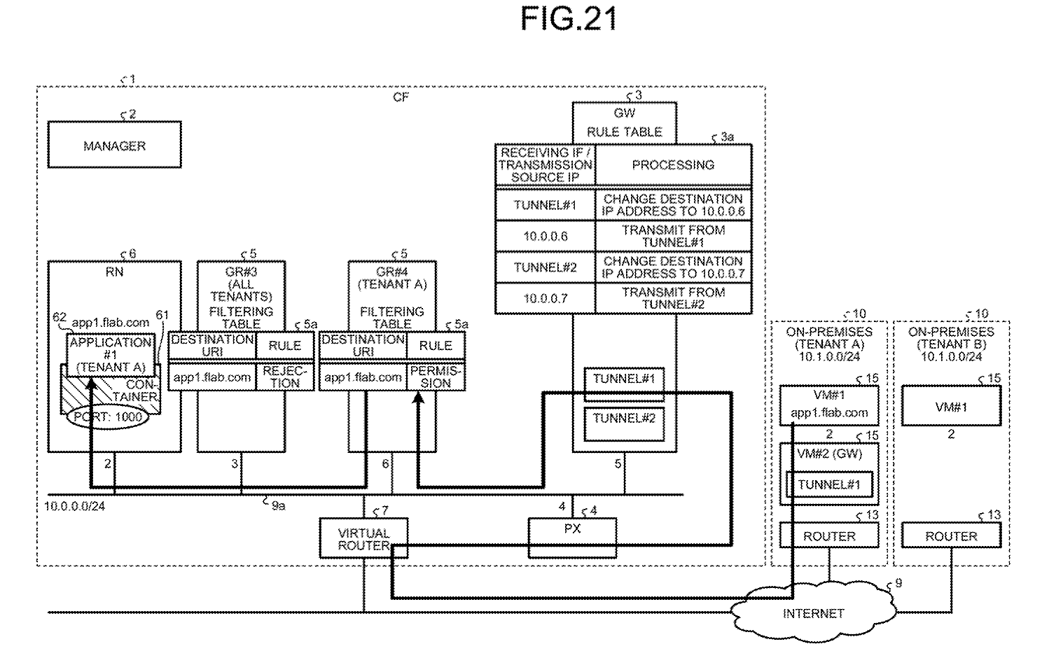

Access of the tenant A to APPLICATION#1 then occurs. FIG. 21 is a diagram for explaining access of the tenant A to APPLICATION#1. As illustrated in FIG. 21, communication with “app1.flab.com” occurs from VM#1 of the tenant A. Once the communication packet reaches the GW 3 via TUNNEL#1, the GW 3 refers to the rule table 3a, converts the destination IP address into “10.0.0.6”, and transmits the communication packet to GR#4. Once the communication packet reaches GE#4, GR#4 refers to the filtering table 5a, permits communication with “app1.flab.com” and transmits the communication packet to the RN 6.

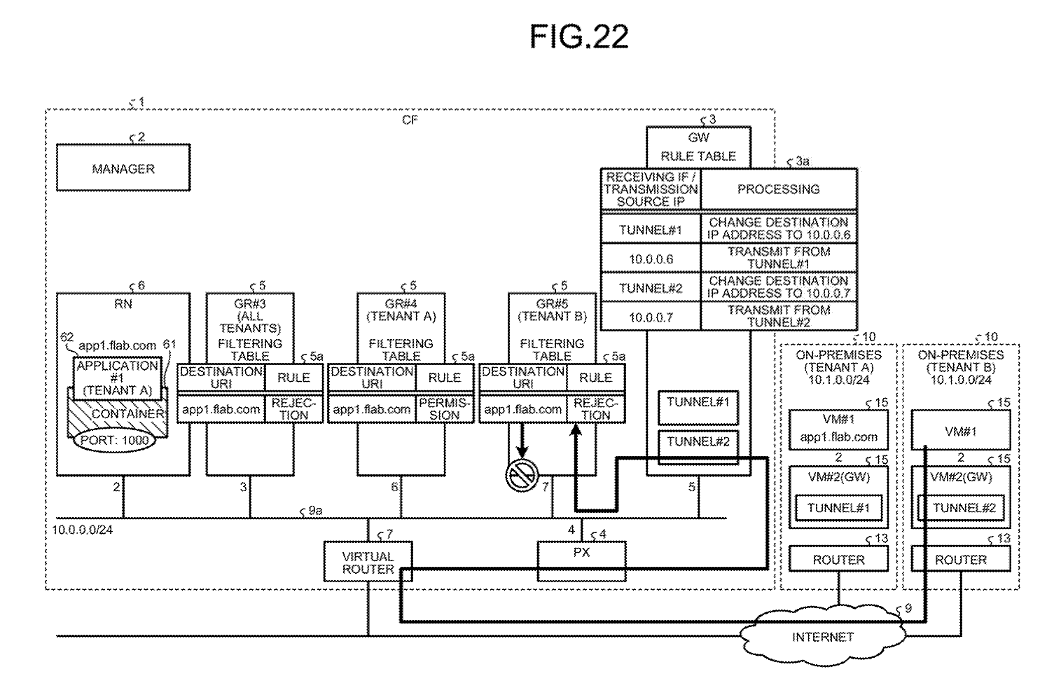

Access of the tenant B to APPLICATION#1 then occurs. FIG. 22 is a diagram for explaining access of the tenant B to APPLICATION#1. According to FIG. 22, the on-premises 10 of the tenant B and the CF 1 are connected with TUNNEL#2. Furthermore, GR#5 for the tenant B is created and the rule indicating that communication with “app1.flab.com” is rejected is registered in the filtering table 5a in GR#5. Furthermore, the processing of transferring the communication packet received from TUNNEL#2 to GR#5 is registered in the rule table 3a of the GW 3. VM#2 that is the VM 15 for GW runs in the on-premises 10 of the tenant 8.

As illustrated in FIG. 22, communication with “app1.flab.com” occurs from VM#1 of the tenant B. Once the communication packet reaches the GW 3 via TUNNEL#2, the GW 3 refers to the rule table 3a, converts the destination IP address into “10.0.0.7”, and transmits the communication packet to GR#5. Once the communication packet reaches GR#5, GR#5 refers to the filtering table 5a, rejects communication with “app1.flab.com” and discards the communication packet.

As described above, according to the first embodiment, on receiving the communication packet from the tunnel 8 that is set for each tenant, the GW 3 refers to the rule table 3a and transmits the communication packet to the GR 5 associated with the tunnel 8. On receiving the communication packet from the GW 3, the GR 5 associated with the tenant refers to the filtering table 5a, determines whether the URI of the destination is permitted and, when the URI is permitted, transmits the communication packet to the RN 6. Accordingly, the CP 1 is able to prevent unauthorized access to the application 62 and provide secure PaaS.

Furthermore, in the first embodiment, the manager 2 creates the information of the rule table 3a, creates the information of the rule table 3a, creates the information of the filtering table 5a, and sets the information in the filtering table 5a. Accordingly, the operator 1b of the CF 1 is able to realize secure PaaS easily.

### Second Embodiment

In the first embodiment, the GR 5 determines whether transferring a communication packet to the RN 6 is permitted or rejected by using the filtering table 5a. Alternatively, the GR5 may determine whether transferring a communication packet to the RN 6 is permitted or rejected without using the filtering table 5a. In a second embodiment, a CF 1d that determines whether transferring a communication packet to the RN 6 is permitted or rejected without using the filtering table 5a will be described.

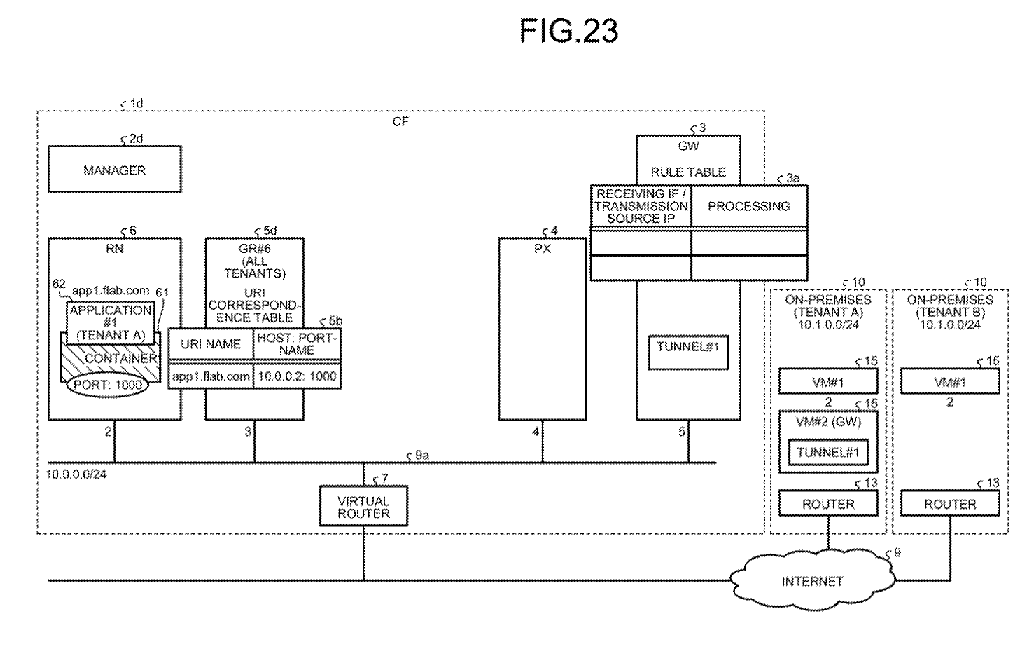

FIG. 23 is a diagram illustrating the state of the CF 1d after configuring the application 62 and TUNNEL#1. For the purpose of illustration, functional units fulfilling the same roles as those of the components illustrated in FIG. 16 are denoted with the same reference numbers and detailed descriptions thereof will be omitted. Compared to FIG. 16, the CF 1d includes a manager 2d instead of the manager 2 and includes a GR 5d represented by GR#6 instead of the GR 5.

The manager 2d has the same function as that of the manager 2 but does not sets the filtering table 5a. The manager 2d registers information about the URI of the application 62 that belongs to the tenant in only a URI correspondence table 5b of the GR 5d dedicated to tenants.

The GR 5d does not have the filtering table 5a. The GR 5d determines whether transferring a communication packet to the RN 6 is permitted or rejected by using the URI correspondence table 5b. In other words, the GR 5d transfers a communication packet to the RN 6 when the URI of the destination of the communication packet is registered in the URI correspondence table 5b, and the GR 5d does not transfers the communication packet to the RN 6 when the URI of the destination of the communication packet is not registered in the URI correspondence table 5b.

The GR 5d determines whether transferring a communication packet to the RN 6 is permitted or rejected by using the URI correspondence table 5b as described above, which enables the CF 1d to determine whether transferring a communication packet to the RN 6 is permitted or rejected without using the filtering table 5a.

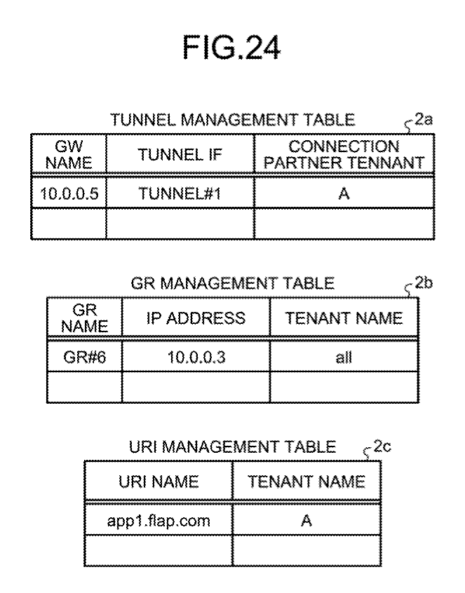

FIG. 24 is a diagram illustrating a table configuration in the manager 2d (after setting of the tunnel 8). As illustrated in FIG. 24, the table configuration in the manager 2d. (after setting of the tunnel 8) is the same as the table configuration in the manager 2 illustrated in FIG. 1 except that the name of the GR 5d registered in the GR management table 2b is GR#6.

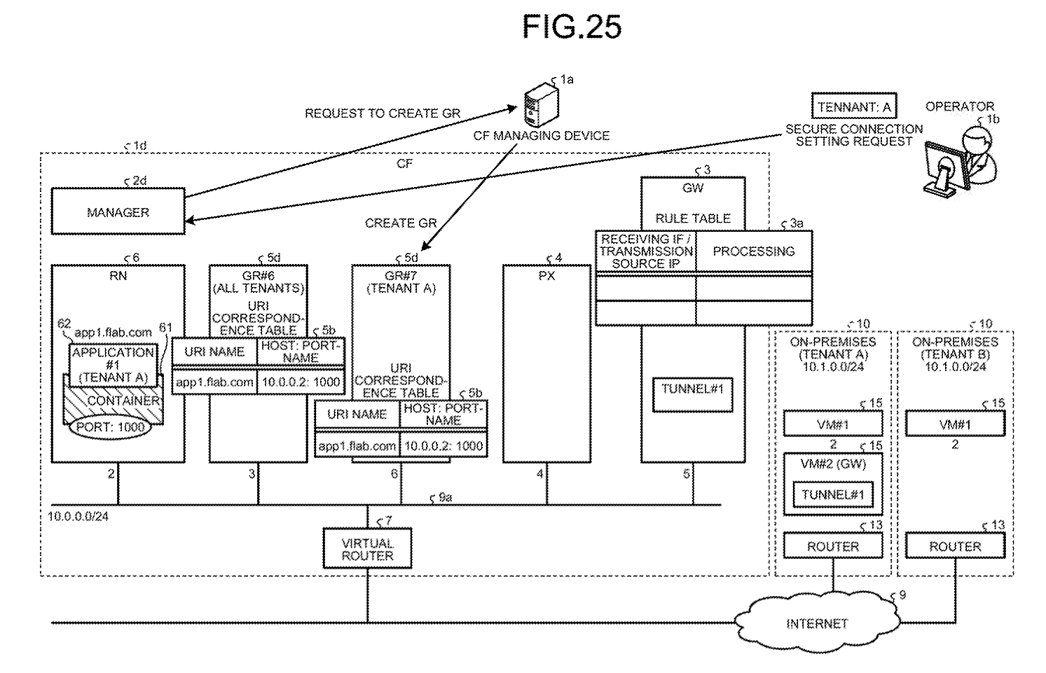

FIG. 25 is a first diagram for explaining setting of secure connection according to the second embodiment. As illustrated in FIG. 25, the manager 2d is notified of a secure connection setting request. The secure connection setting request contains the tenant name “A”. The manager 2d then requests the CF managing device 1a to create the GR 5d. The GR 5d represented by GR#7 is then created. In the URI correspondence table 5b in GR#7, information about APPLICATION#1 is registered. The manager 2d updates the GR management table 2b by using information about GR#7 that is created.

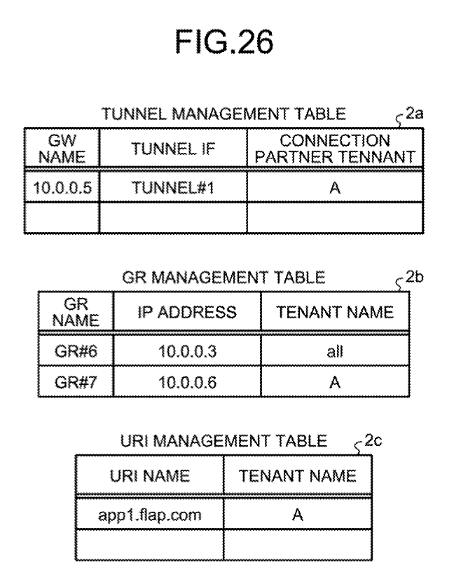

FIG. 26 is a diagram illustrating a table configuration in the manager 2d. (after setting of secure connection). As illustrated in FIG. 26, the GR name “GR#7” the IP address “10.0.0.6”, and the tenant name “A” are registered in the updated GR management table 2b.

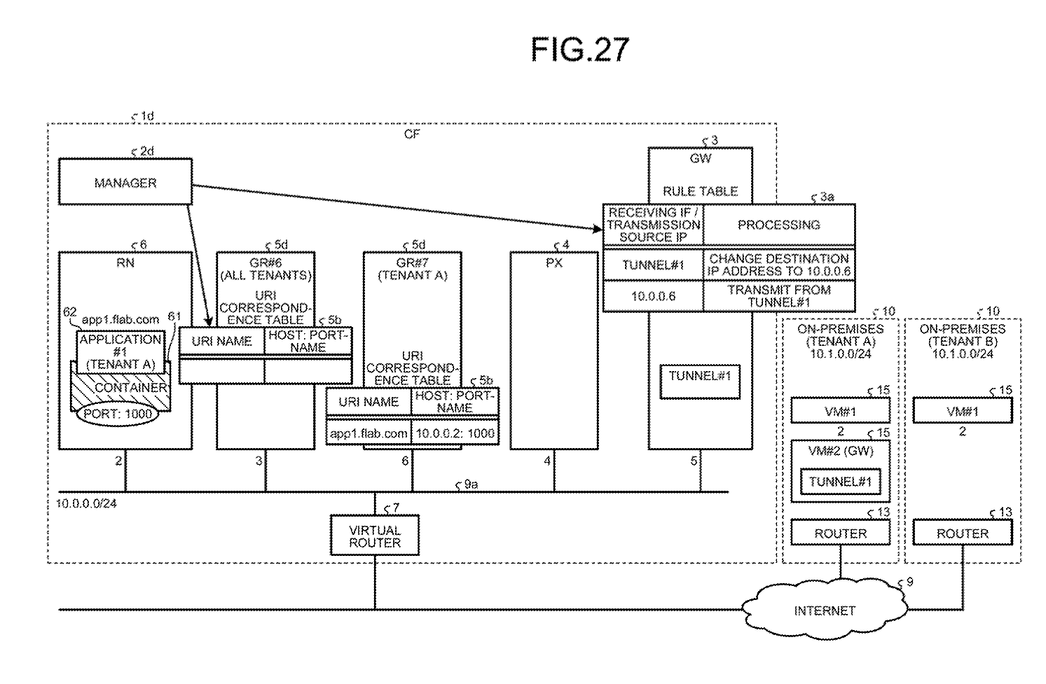

FIG. 27 is a second diagram for explaining setting of secure connection according to the second embodiment. As illustrated in FIG. 27, the manager 2d changes the URI correspondence table 5b in GR#6. In other words, the manager 2d deletes information about APPLICATION#1 from the URI correspondence table 5b in GR#6.

The manager 2d sets the rule table 3a of the GW 3. In the rule table 3a of the GW 3, processing of changing the IP address of the destination of the communication packet received from TUNNEL#1 to “10.0.0.6” is registered in association with TUNNEL#1 and registers processing of transmission from TUNNEL#1 is registered in association with the IP address of GR#7.

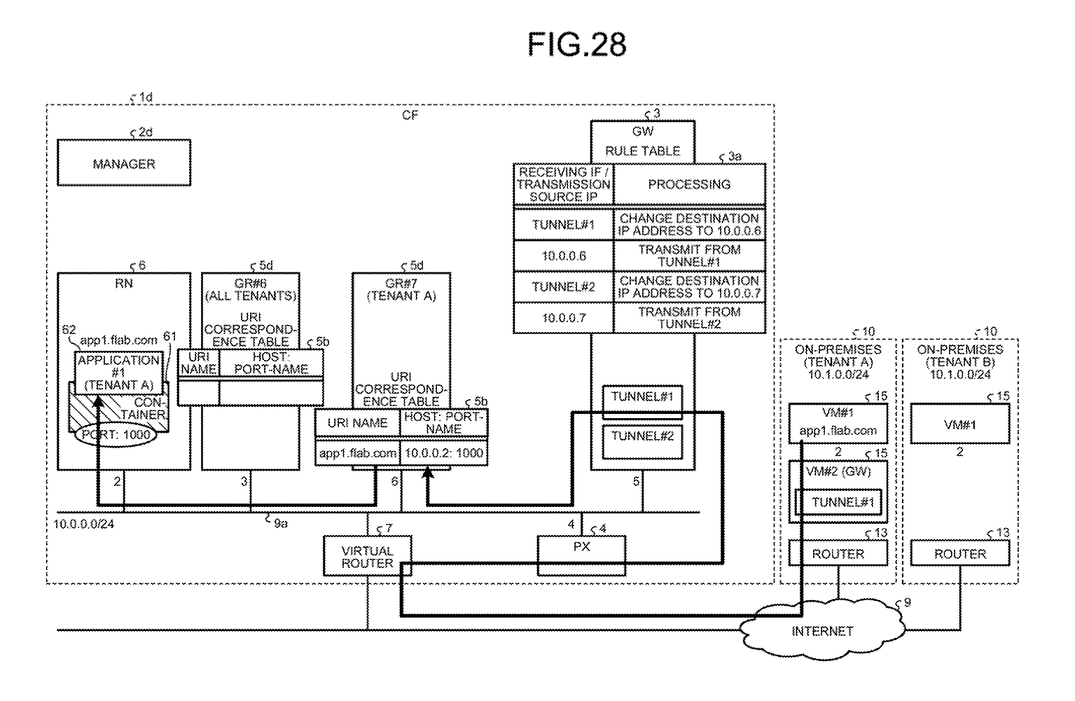

Access of the tenant A to APPLICATION#1 occurs. FIG. 28 is a diagram for explaining access of the tenant A to APPLICATION#1. As illustrated in FIG. 28, communication with “app1.flab.com” occurs from VM#1 of the tenant A. Once the communication packet reaches the GW 3 via TUNNEL#1, the GW 3 refers to the rule table 3a, converts the destination IP address into “10.0.0.6” and transmits the communication packet to GR#7. Once the communication packet reaches GR#7, GR#7 refers to the URI correspondence table 5b, permits communication with “app1.flab.com”, and transmits the communication packet to the RN 6.

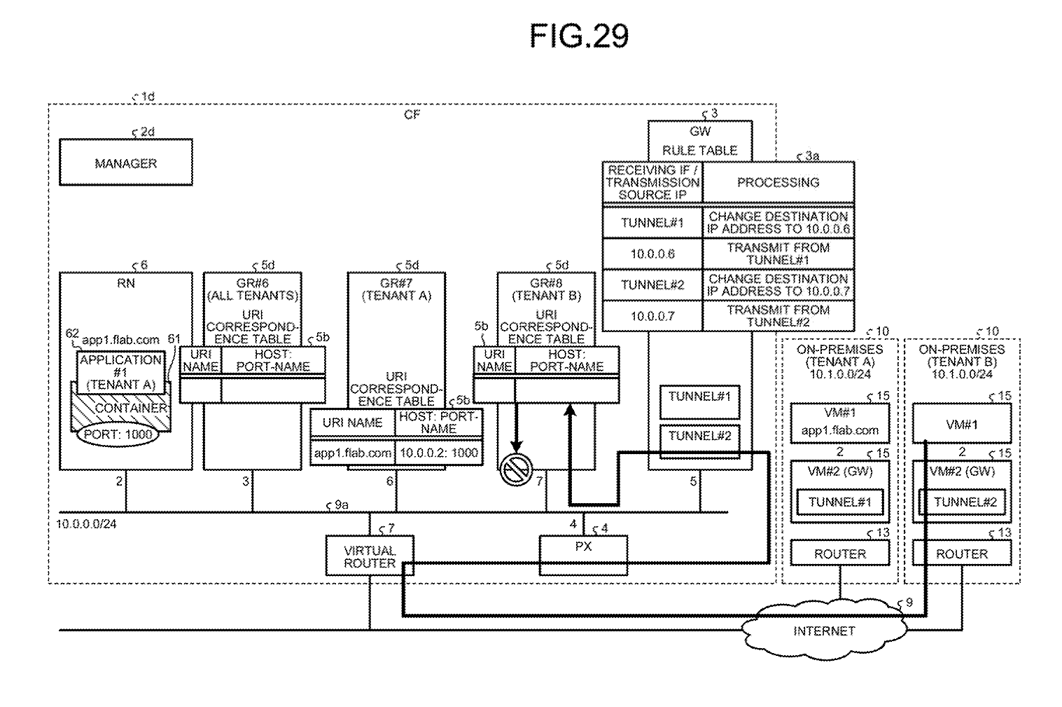

Access to APPLICATION#1 occurs from the tenant 8. FIG. 29 is a diagram for explaining access of the tenant B to APPLICATION#1. According to FIG. 29, the on-premises 10 of the tenant B and the CF 1d are connected via TUNNEL#2. Furthermore, GR#8 for the tenant E is created and information about APPLICATION#1 is not registered in the URI correspondence table 5b of GR#8. Furthermore, processing of transferring a communication packet received from TUNNEL#2 to GR#8 is registered in the rule table 3a of the GW 3. In the on-premises 10 of the tenant B, VM#2 that is the VM 15 for GW runs.

As illustrated in FIG. 29, communication towards “app1.flab.com” occurs from VM#1 of the tenant B. When the communication packet reaches the GW 3 via TUNNEL#2, the GW 3 refers to the rule table 3a, converts the destination IP address into “10.0.0.7”, and transmits the communication packet to GR#8. Once the communication packet reaches GR#8, GR#3 refers to the ORI correspondence table 5b and, as “app1.flab.com” is not registered, rejects communication with “app1.flab.com” and discards the communication packet.

As described above, in the second embodiment, the GR 5d transfers a communication packet to the RN 6 when the URI of the destination of the communication packet is registered in the URI correspondence table 5b, and the GR 5d does not transfer the communication packet to the RN 6 when the URI of the destination of the communication packet is not registered in the URI correspondence table 5b. Accordingly, the CF 1d enables efficient transfer of communication packets to the RN 6.

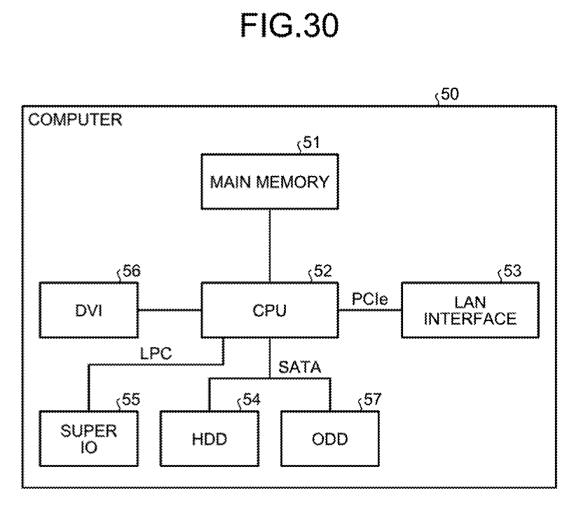

In the first and second embodiments, the VMs are described. The VMs are executed by a physical machine, i.e., a computer. The computer that executes the VMs will be described. FIG. 30 is a diagram illustrating a hardware configuration of a computer chat executes the VMs. As illustrated in FIG. 30, a computer 50 includes a main memory 51, a central processing unit (CPU) 52, a local area network (LAN) interface 53, and a hard disk drive (HDD) 54. The computer 50 further includes a super input output (IO) 55, a digital visual interface (DVI) 56, and an optical disk drive (57).

The main memory 51 is a memory that stores a program, the halfway result of execution of the program, etc. The CPU 52 is a central processing unit that reads the program from the main memory 51 and executes the program. The CPU 52 includes a chip set including a memory controller.

The LAN interface 53 is an interface for connecting the computer 50 to another computer via a LAN. The HDD 54 is a disk device that stores a program and data and the super IO 55 is an interface to which input devices, such as a mouse and a keyboard, are connected. The DVI 56 is an interface to which a liquid crystal display is connected and the ODD 57 is a device that reads and writes in a DVD.

The LAN interface 53 is connected to the CPU 52 via a PCI express (PCIe) and the HDD 54 and the ODD 57 are connected to the CPU 52 by serial advanced technology attachment (SATA). The super IO 55 is connected to the CPU 52 by low pin count (LPC).

Furthermore, the embodiments illustrate the CFs; however, the present invention is not limited thereto. The present invention is applicable to another type of software that provides Paas.

According to one aspect of the embodiments, it is possible to provide secure PaaS.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A non-transitory computer readable recording medium having stored therein a PaaS connection program enabling connection to an execution environment in which an application that provides services by PaaS, the PaaS connection program causing a computer to execute a process comprising:
on receiving data from a tunnel that is set for each tenant to which the application belongs, transferring the data to a transfer destination that is associated with the tunnel; and
by the transfer destination, determining whether transferring the transferred data to the execution environment that is associated with a destination contained in the data is permitted and, when the transferring is permitted, transferring the data to the execution environment.

2. The non-transitory computer readable recording medium according to claim 1, wherein the determining and the transferring by the transfer destination include determining whether transferring the data to the execution environment is permitted according to filtering information in which the destination and whether transferring the data
is permitted or rejected are associated with each other and, when the transferring is permitted, transferring the data to the execution environment according to transfer destination information in which the destination and the execution environment are associated with each other.

3. The non-transitory computer readable recording medium according to claim 1, wherein the determining and the transferring by the transfer destination include determining whether transferring the data to the execution environment is permitted according to whether the destination is contained in transfer destination information in which the destination and the execution environment are associated with each other and, when the transferring is permitted, transferring the data to the execution environment according to the transfer destination information.

4. The non-transitory computer readable recording medium according to claim 2, wherein the process further comprises creating the filtering information and setting the filtering information in the transfer destination.

5. The non-transitory computer readable recording medium according to claim 4, wherein the creating and the setting include, on receiving a request of setting secure connection to a tenant, requesting a PaaS managing device that manages the PaaS connection program to create the transfer destination corresponding to the tenant, creating the filtering information about the created transfer destination, and setting the filtering information in the created transfer destination.

6. The non-transitory computer readable recording medium according to claim 1, wherein the process further comprises, on receiving response data from the transfer destination, transmitting the response data to the tunnel.

7. A PaaS connection method enabling connection to an execution environment, in which an application that provides services by PaaS, the method comprising;
on receiving data from a tunnel that is set for each tenant to which the application belongs, transferring the data to a transfer destination that is associated with the tunnel; and
by the transfer destination, determining whether transferring the transferred data to the execution environment that is associated with a destination contained in the data is permitted and, when the transferring is permitted, transferring the data to the execution environment.

8. A PaaS connection device that connects to a processor in which an application that provides services by PaaS, the PaaS connection device comprising:
a gateway unit that, on receiving data from, a tunnel that is set for each tenant to which the application belongs, transfers the data to a transfer determining unit that is associated with the tunnel; and
the transfer determining unit that determines whether transferring the data transferred by the gateway unit to the processor that is associated with a destination contained in the data is permitted and, when the transferring is permitted, transfers the data to the processor.
